(19) United States
(12) Patent Application Publication
(10) Pub. No.: US 2025/0063362 A1
(43) Pub. Date: Feb. 20, 2025

(54) MECHANISM FOR AUTHORIZING DATA EXCHANGE

(71) Applicant: Nokia Technologies Oy, Espoo (FI)

(72) Inventors: Saurabh KHARE, Bangalore (IN); Chaitanya AGGARWAL, Munich (DE)

(21) Appl. No.: 18/788,531

(22) Filed: Jul. 30, 2024

(30) Foreign Application Priority Data
Aug. 14, 2023 (IN) 202311054636

(51) Int. Cl. H04W 12/084

(52) U.S. Cl. CPC H04W 12/084

(57) ABSTRACT

An apparatus for performing: defining an authorization policy per UE, the authorization policy indicating which data are allowed to be accessed by which UE, configuring an authorization policy to one or more UE by providing a key material usable for validating an access token and information regarding the authorization policy indicating an allowance for connection between a requester UE and a producer element or a producer function with a valid access token or without an access token, receiving a request for authorization of a requester UE to access to specified data from a producer element or producer function, processing the request for authorization of the requester UE for deciding whether the request is allowed, and in case the request is allowed, obtain an access token for allowing access to the specified data from the producer element or producer function, and transmitting the access token to the requester UE.

### BACKGROUND

### Field

Examples of embodiments described herein relate to apparatuses, methods, systems, computer programs, computer program products and (non-transitory) computer-readable media usable for conducting authorization procedures allowing to exchange data between a requester UE and a producer element or producer function, such as another UE or a suitable network element or network function. In particular, some examples of embodiments relate to apparatuses, methods, systems, computer programs, computer program products and (non-transitory) computer-readable media usable for a mechanism which enables to authorize a requestor UE to access to AIML related data from a corresponding producer element or function.

### Background

The following description of background may include insights, discoveries, understandings or disclosures, or associations, together with disclosures that are not already known, but rather provided herein by the disclosure as one or more examples of embodiments. Some of examples of embodiments may be specifically pointed out below, whereas other of such contributions will be apparent from the related context.

The following meanings for the abbreviations used herein apply:
3GPP 3^{rd} Generation Partnership Project
4G fourth generation
5G fifth generation
5GC 5G core
AKA authentication and key agreement
AKMA authentication and key management for application
AUSF authentication server function
CN core network
CPU central processing unit
D2D device-to-device
eNB E-UTRAN Node B
gNB next generation node B
HPLMN home PLMN
ID identification, identifier
IP Internet protocol
KID key identifier
LTE Long Term Evolution
LTE-A LTE Advanced
MSISDN mobile subscriber ISDN number
NAS non-access stratum
NF network function
NG next generation
NW network, network side
PLMN public land mobile network
ProSe proximity based service
RAN radio access network
UDM unified data manager
UE user equipment
UPU UE parameter update
WLAN wireless local area network

### SUMMARY

According to an example of an embodiment, there is provided, for example, an apparatus comprising at least one processor, and at least one memory for storing instructions that, when executed by the at least one processor, cause the apparatus at least to perform: defining an authorization policy per user equipment, the authorization policy indicating which data are allowed to be accessed by which user equipment, configuring an authorization policy to one or more user equipments by providing a key material usable for validating an access token and information regarding the authorization policy indicating an allowance for connection between a requester user equipment and a producer element or a producer function with a valid access token or without an access token, receiving a request for authorization of a requester user equipment to access to specified data from a producer element or producer function, processing the request for authorization of the requester user equipment for deciding whether the request is allowed, and in case the request is allowed, obtain an access token for allowing access to the specified data from the producer element or producer function, and transmitting the access token to the requester user equipment.

Furthermore, according to an example of an embodiment, there is provided, for example, a method comprising defining an authorization policy per user equipment, the authorization policy indicating which data are allowed to be accessed by which user equipment, configuring an authorization policy to one or more user equipments by providing a key material usable for validating an access token and information regarding the authorization policy indicating an allowance for connection between a requester user equipment and a producer element or a producer function with a valid access token or without an access token, receiving a request for authorization of a requester user equipment to access to specified data from a producer element or producer function, processing the request for authorization of the requester user equipment for deciding whether the request is allowed, and in case the request is allowed, obtain an access token for allowing access to the specified data from the producer element or producer function, and transmitting the access token to the requester user equipment.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy may be user equipments being signed to use one or more AIML services;
   for providing the key material and the information regarding the authorization policy, one of a non-access stratum, NAS, signalling or a user parameter provisioning signaling may be used for a transmission to the one or more user equipments;
the data indicated in the authorization policy may comprise at least one or more of the following: an AIML model identification, an AIML event identification, or a data topic identification, wherein user equipments allowed to access the data may be identified by at least one of the following: a predefined list of user equipments, an indication of an specified area where a user equipment is located, an indication of a communication network to which a user equipment belongs, or an indication that any user equipment is allowed;
   the request for authorization of the requester user equipment may be received from one of the requester user equipment or from a control network element or control network function of another communication network;
   with the access token transmitted to the requester user equipment, information indicating at least one the following may be indicated: information identifying at least one producer element or producer function for prompting the requester user equipment to contact only an identified producer element or producer function as a target for requesting the specified data, or information indicating specified resources of data for prompting the requester user equipment to request only the indicated resources from a suitable producer element or producer function, wherein the access token may be a generic access token;
   when receiving the request for authorization of the requester user equipment, it may be determined whether a unique temporary identifier for the producer element or producer function is included which is related to another communication network, and in case the determination is affirmative, the request for authorization of the requester user equipment may be forwarded to a control network element or control network function of the other communication network for obtaining the access token, the access token may be received from the control network element or control network function of the other communication network, and the received access token may be transmitted to the requester user equipment;
the unique temporary identifier may be configured in the producer element or producer function by a control network element or control network function, or generated by the producer element or producer function;
   when the processing of the request for authorization of the requester user equipment is decided to be allowed, the access token for allowing access to the specified data from the producer element or producer function may be generated, and the generated access token may be transmitted to the requester user equipment;
   for processing of the request for authorization of the requester user equipment, it may be decided on whether the request is allowed or not on the basis of an operator policy and subscription data of the producer element or producer function;
   the access token may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
   the access token may be signed by a private key, wherein the key material may be a corresponding public key used to validate the access token at the producer element or producer function;
   the specified data indicated in the request for authorization of the requester user equipment may include at least one of the following: AIML model data, AIML training data, or AIML analysis data.
   the request for authorization of the requester user equipment may include an identification of a producer element or producer function;
   the apparatus may comprises or may be comprised in one of a core network control element or core network control function, an access network control element or access network control function, or the apparatus may comprise or may be comprised in a unified data management entity.

According to an example of an embodiment, there is provided, for example, an apparatus comprising at least one processor, and at least one memory for storing instructions that, when executed by the at least one processor, cause the apparatus at least to perform: receiving configuration information regarding an authorization policy from a control network element or control network function including key material usable for validating an access token and information indicating an allowance for connection between a requester user equipment and a producer element or a producer function with a valid access token or without an access token, transmitting, to the control network element or control network function, a request for authorization to access to specified data from a producer element or producer function, receiving, in response to the request, an access token for allowing access to the specified data from the producer element or producer function, and sending a request to the producer element or producer function for being provided with the specified data, wherein the received access token is included in the request.

Furthermore, according to an example of an embodiment, there is provided, for example, a method comprising receiving configuration information regarding an authorization policy from a control network element or control network function including key material usable for validating an access token and information indicating an allowance for connection between a requester user equipment and a producer element or a producer function with a valid access token or without an access token, transmitting, to the control network element or control network function, a request for authorization to access to specified data from a producer element or producer function, receiving, in response to the request, an access token for allowing access to the specified data from the producer element or producer function, and sending a request to the producer element or producer function for being provided with the specified data, wherein the received access token is included in the request.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy are user equipments being signed to use one or more AIML services;
the key material and the information regarding the authorization policy may be received by using one of a non-access stratum, NAS, signalling or a user parameter provisioning signaling for a transmission from the control network element or control network function,
the producer element or producer function indicated in the request for authorization to access to the specified data may be one of a producer user equipment or a producer communication network element or producer communication network function;
the access token received from the control network element or control network function may comprise information indicating at least one the following: information identifying at least one producer element or producer function for prompting to contact only an identified producer element or producer function as a target for requesting the specified data, or information indicating specified resources of data for prompting to request only the indicated resources from a suitable producer element or producer function, wherein the access token is a generic access token;
the specified data indicated in the request for authorization may include at least one of the following: AIML model data, AIML training data, or AIML analysis data;
the request for authorization may include an identification of a producer element or producer function,
the access token may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
the access token may signed by a private key, wherein the key material may be a corresponding public key used to validate the access token at the producer element or producer function;
a unique temporary identifier assigned for preserving privacy in a device to device communication may be obtained, wherein the unique temporary identifier may be received from the control network element or control network function, or the unique temporary identifier may be generated, wherein the unique temporary identifier may be indicated in the request for authorization to access the specified data available at the producer element or producer function identified by unique temporary identifier,
from a producer element or producer function from which specified data are to be obtained, a second unique temporary identifier of the producer element or producer function assigned for preserving privacy in a device to device communication may be received, and the second unique temporary identifier may be indicated as an identification of the producer element or producer function in the request for authorization to access the specified data;
the received access token may be stored;
the request for authorization to access to specified data to the control network element or control network function may be transmitted after receiving an inquiry from the producer element or producer function to present the access token;
the requested specified data may be received from the producer element or producer function.

According to an example of an embodiment, there is provided, for example, an apparatus comprising at least one processor, and at least one memory for storing instructions that, when executed by the at least one processor, cause the apparatus at least to perform: receiving configuration information regarding an authorization policy from a control network element or control network function including key material usable for validating an access token and information indicating an allowance for connection between a requester user equipment and a producer element or a producer function with a valid access token or without an access token, receiving, from a requester user equipment, a request for specified data to be provided from a producer element or producer function, wherein the request comprises an access token for allowing access to the specified data from the producer element or producer function, determining a validity of the received access token, and if validity of the access token is confirmed, sending the requested specified data to the requester user equipment.

Furthermore, according to an example of an embodiment, there is provided, for example, a method comprising receiving configuration information regarding an authorization policy from a control network element or control network function including key material usable for validating an access token and information indicating an allowance for connection between a requester user equipment and a producer element or a producer function with a valid access token or without an access token, receiving, from a requester user equipment, a request for specified data to be provided from a producer element or producer function, wherein the request comprises an access token for allowing access to the specified data from the producer element or producer function, determining a validity of the received access token, and if validity of the access token is confirmed, sending the requested specified data to the requester user equipment.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy are user equipments being signed to use one or more AIML services;
the key material and the information regarding the authorization policy may be received by using one of a non-access stratum, NAS, signalling or a user parameter provisioning signaling for a transmission from the control network element or control network function;
the specified data indicated in the request may include at least one of the following: AIML model data, AIML training data, or AIML analysis data;
the access token may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
the access token may be signed by a private key, wherein the key material may be a corresponding public key used to validate the access token at the producer element or producer function;
a unique temporary identifier assigned for preserving privacy in a device to device communication may be obtained, wherein the unique temporary identifier may be received from a control network element or control network function, or the unique temporary identifier may be generated, wherein the unique temporary identifier may be indicated to a requestor user equipment trying to access specified data;
an inquiry may be transmitted to a requester user equipment to present an access token;
the apparatus may comprise or may be comprised in the producer element or producer function and wherein the producer element or producer function may be one of a producer user equipment or a producer communication network element or a producer communication network function.

According to an example of an embodiment, there is provided, for example, an apparatus comprising at least one processor, and at least one memory for storing instructions that, when executed by the at least one processor, cause the apparatus at least to perform: defining an authorization policy per user equipment, the authorization policy indicating which data are allowed to be accessed by which user equipment, configuring an authorization policy by pushing authorization policy information to a network element or network function and to one or more user equipments, the authorization policy information indicating an allowance for connection between a requester user equipment and a producer element or a producer function, receiving a request for authorization of a requester user equipment to access to specified data from a producer element or producer function, processing the request for authorization of the requester user equipment for deciding whether the request is allowed.

Furthermore, according to an example of an embodiment, there is provided, for example, a method comprising defining an authorization policy per user equipment, the authorization policy indicating which data are allowed to be accessed by which user equipment, configuring an authorization policy by pushing authorization policy information to a network element or network function and to one or more user equipments, the authorization policy information indicating an allowance for connection between a requester user equipment and a producer element or a producer function, receiving a request for authorization of a requester user equipment to access to specified data from a producer element or producer function, processing the request for authorization of the requester user equipment for deciding whether the request is allowed.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy are user equipments being signed to use one or more AIML services;
in case the request is allowed, the requester user equipment may be authorized to access the specified data from the producer element or producer function, and an indication of the authorization may be transmitted to the requester user equipment;
with the indication of the authorization, information related to the producer element or producer function may be provided;
the data indicated in the authorization policy may comprise at least one or more of the following: an AIML model identification, an AIML event identification, or a data topic identification, wherein user equipments allowed to access the data may be identified by at least one of the following: a predefined list of user equipments, an indication of an specified area where a user equipment is located, an indication of a communication network to which a user equipment belongs, or an indication that any user equipment is allowed;
the request for authorization of the requester user equipment may be received from one of the requester user equipment or from a control network element or control network function of another communication network;
when receiving the request for authorization of the requester user equipment, it may be determined whether a unique temporary identifier for the producer element or producer function is included which is related to another communication network, and in case the determination is affirmative, the request for authorization of the requester user equipment may be forwarded to a control network element or control network function of the other communication network for obtaining an indication that the request is allowed, and the received indication of the authorization may be transmitted to the requester user equipment;
the unique temporary identifier may be configured in the producer element or producer function by a control network element or control network function, or generated by the producer element or producer function;
for processing of the request for authorization of the requester user equipment, it may be decided on whether the request is allowed or not on the basis of an operator policy and subscription data of the producer element or producer function;
it may be checked whether the authorization policy information pushed to a network element, a network function or a user equipment being the producer element or producer function is sufficient for the specified data being indicated in the request for authorization, an in case it is determined that the authorization policy information pushed to the network element, the network function or the user equipment being the producer element or producer function is not sufficient for the specified data, the authorization policy information may be updated in the network element, the a network function or the user equipment being the producer element or producer function;
the authorization policy information may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
the specified data indicated in the request for authorization of the requester user equipment may include at least one of the following: AIML model data, AIML training data, or AIML analysis data;
the apparatus may comprise or may be comprised in one of a core network control element or core network control function, an access network control element or access network control function, or a unified data management entity, or the apparatus may comprise or may be comprised in a unified data management entity.

According to an example of an embodiment, there is provided, for example, an apparatus comprising at least one processor, and at least one memory for storing instructions that, when executed by the at least one processor, cause the apparatus at least to perform: receiving, from a control network element or control network function, authorization policy information indicating an allowance for connection between a requester user equipment and a producer element or a producer function, transmitting, to the control network element or control network function, a request for authorization to access to specified data from a producer element or producer function, receiving, in response to the request, an indication that the access to the specified data from the producer element or producer function is allowed, and sending, after receiving the indication that the access to the specified data from the producer element or producer function is allowed, a request to the producer element or producer function for being provided with the specified data.

Furthermore, according to an example of an embodiment, there is provided, for example, a method comprising receiving, from a control network element or control network function, authorization policy information indicating an allowance for connection between a requester user equipment and a producer element or a producer function, transmitting, to the control network element or control network function, a request for authorization to access to specified data from a producer element or producer function, receiving, in response to the request, an indication that the access to the specified data from the producer element or producer function is allowed, and sending, after receiving the indication that the access to the specified data from the producer element or producer function is allowed, a request to the producer element or producer function for being provided with the specified data.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy are user equipments being signed to use one or more AIML services;
the indication of the authorization further may comprise information related to the producer element or producer function;
the producer element or producer function indicated in the request for authorization to access to the specified data may be one of a producer user equipment or a producer communication network element or producer communication network function;
the authorization policy information may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
the specified data indicated in the request for authorization may include at least one of the following: AIML model data, AIML training data, or AIML analysis data;
the request for authorization may include an identification of a producer element or producer function;
a unique temporary identifier assigned for preserving privacy in a device to device communication may be obtained, wherein the unique temporary identifier may be received from the control network element or control network function, or the unique temporary identifier may be generated, wherein the unique temporary identifier may be indicated in the request for authorization to access the specified data;
from a producer element or producer function from which specified data are to be obtained, a second unique temporary identifier of the producer element or producer function assigned for preserving privacy in a device to device communication may be received, and the second unique temporary identifier may be indicated as an identification of the producer element or producer function in the request for authorization to access the specified data;
the requested specified data may be received from the producer element or producer function;

According to an example of an embodiment, there is provided, for example, an apparatus comprising at least one processor, and at least one memory for storing instructions that, when executed by the at least one processor, cause the apparatus at least to perform: receiving, from a control network element or control network function, authorization policy information indicating an allowance for connection between a requester user equipment and a producer element or a producer function, receiving, from a requester user equipment, a request for specified data to be provided from a producer element or producer function, determining a validity of the request on the basis of the received authorization policy information, and if validity of the request is confirmed, sending the requested specified data to the requester user equipment.

Furthermore, according to an example of an embodiment, there is provided, for example, a method comprising receiving, from a control network element or control network function, authorization policy information indicating an allowance for connection between a requester user equipment and a producer element or a producer function, receiving, from a requester user equipment, a request for specified data to be provided from a producer element or producer function, determining a validity of the request on the basis of the received authorization policy information, and if validity of the request is confirmed, sending the requested specified data to the requester user equipment.

According to further refinements, these examples may include one or more of the following features:
the data allowed to be accessed to which the authorization policy is related and the specified data which are requested to be accessed may concern data related to artificial intelligence machine learning, AIML, services, wherein the one or more user equipments configured with the authorization policy are user equipments being signed to use one or more AIML services;
the specified data indicated in the request may include at least one of the following: AIML model data, AIML training data, or AIML analysis data;
an update for the authorization policy information may be received from the control network element or control network function;
the authorization policy information may comprise at least one of the following: an identification of a source user equipment of the request, an identification of a producer element or producer function of the requested data, an identification of a communication network where the producer element or producer function of the requested data is located, or an indication of a connection type to be used for obtaining the requested data from the producer element or producer function;
a unique temporary identifier assigned for preserving privacy in a device to device communication may be obtained, wherein the unique temporary identifier may be received from a control network element or control network function, or the unique temporary identifier may be generated, wherein the unique temporary identifier may be indicated to a requester user equipment trying to access specified data;
the apparatus may comprise or may be comprised in the producer element or producer function and wherein the producer element or producer function is one of a producer user equipment or a producer communication network element or a producer communication network function;

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of: upload; download; and/or push procedures.

### BRIEF DESCRIPTION OF THE DRAWINGS

Some examples of disclosure related to embodiments are described below, by way of example only, with reference to the accompanying drawings, in which:

FIG. 1 shows a diagram illustrating an example for a communication scenario according to examples of embodiments;

FIG. 2 shows a diagram illustrating an example for a communication scenario according to examples of embodiments;

FIG. 3 shows a signaling diagram illustrating an example of an authorization procedure according to examples of embodiments;

FIG. 4 shows a signaling diagram illustrating an example of an authorization procedure according to examples of embodiments;

FIG. 5 shows a signaling diagram illustrating an example of an authorization procedure according to examples of embodiments;

FIG. 6 shows a signaling diagram illustrating an example of an authorization procedure according to examples of embodiments;

FIG. 7 shows a flow chart of a processing conducted in a control element according to some examples of embodiments;

FIG. 8 shows a flow chart of a processing conducted in requester UE according to some examples of embodiments;

FIG. 9 shows a flow chart of a processing conducted in a producer element or producer function according to some examples of embodiments;

FIG. 10 shows a diagram of a communication network control element according to some examples of embodiments;

FIG. 11 shows a diagram of a requester UE according to some examples of embodiments;

FIG. 12 shows a diagram of a producer element or function according to some examples of embodiments;

FIG. 13 shows a flow chart of a processing conducted in a control element according to some examples of embodiments;

FIG. 14 shows a flow chart of a processing conducted in requester UE according to some examples of embodiments;

FIG. 15 shows a flow chart of a processing conducted in a producer element or producer function according to some examples of embodiments;

FIG. 16 shows a diagram of a communication network control element according to some examples of embodiments;

FIG. 17 shows a diagram of a requester UE according to some examples of embodiments; and

FIG. 18 shows a diagram of a producer element or function according to some examples of embodiments.

### DETAILED DESCRIPTION

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Basically, for properly establishing and handling a communication between two or more endpoints (e.g. communication stations or elements, such as terminal devices, user equipments (UEs), or other communication network elements, a database, a server, host etc.), one or more network elements or functions (e.g. physical nodes or virtualized network functions), such as communication network control elements or functions, for example access network elements like access points, radio base stations, relay stations, eNBs, gNBs etc., and core network elements or functions, for example control nodes, support nodes, service nodes, gateways, user plane functions, access and mobility functions etc., may be involved, which may belong to one communication network system or different communication network systems. However, it is to be noted that also a communication without intermediate network element is basically possible.

In communication networks, such as 3GPP based networks, one goal is to enhance performance. One approach to achieve this is the usage of artificial intelligence (AI)/machine learning (ML) concepts.

AI/ML can be used to manage complex network intelligently, address system optimization problems, and improve user experience in e.g. 5G system and beyond.

AI/ML models find application in mobile devices in 5G system, e.g., image recognition, speech recognition, and video processing. Due to diverse applications, changing environment, and limited storage at user equipment (UE), it is not optimal to load all AI/ML models in UE in advance. Thus, downloading AI/ML models or AI/ML related data as needed is required. Furthermore, for some applications, an UE may not have sufficient computation resource to perform inference, in which case the inference operation may need to be offloaded from UE to the network, e.g. the 5G cloud or edge. Also training data have to be shared across different entities that collaboratively train a global AI/ML model in 5G system. Transferring AI/ML models and data causes traffic that needs to be served by 5G system.

When considering security aspects of AI/ML enhancements, the following is to be considered. Concepts are to be developed to allow an AI-enabled network architecture and to leverage AI/ML to enable 5GC and air interface intelligence in terms of data collection, ML model training, analytics inference, and closed-loop procedures by consuming data analytics. Based on this, it is considered to expand the scope of network AI services to leverage AI/ML technologies to enable 5GC and air interface intelligence by providing network automation and improving the efficiency of 5G network architecture.

Furthermore, also security aspects have to be considered. These aspects concern, for example, AI/ML alignment and convergence for air interface and 5GC, how to support model transfer/delivery to a UE, security and privacy aspects on data collection and model transfer/delivery to UE (e.g. in terms of authentication, authorization, subscription management).

Specifically, the following issues are to be considered when e.g. sharing AI/ML models and related data. A mechanism is to be provided which enables authorization for a consumer UE (also referred to as a requester UE) to request and consume an AI/ML model, its training data or and/or analytics data which is available at 5G Core and/or RAN. A corresponding mechanism is also required in case the desired model/data is already available at one or more producer elements or functions, such as in one or more producer UEs or producer network elements, which are located e.g. in the vicinity of the requester UE and could thus be contacted by using a direct connection between the UEs, such as a D2D connection, ProSe based connection or the like. In this case, it would be required to ensure/verify by a producer UE that the consumer UE is authorized to consume the model and/or related data.

Hence, it is necessary to provide a mechanism enabling to provide UE level authorization e.g. in 5GS for enabling the sharing of AI/ML models or related training/analysis data between a consumer UE and 5GC/RAN, or between a consumer UE and a producer UE. Such a mechanism should be also applicable for enabling cross domain AI ML model and training data sharing.

Therefore, according to examples of embodiments, a mechanism is proposed which is related to an authorization mechanism which enables basically an authorization for a requester UE to access to data in a producer UE or a producer network element or producer network function (both referred to as a producer element or producer function, in the following). More specifically, an authorization mechanism is proposed which enables an authorization for a requester UE to access, in a producer UE or the like, data for model/analytics/data sharing.

For a corresponding mechanism, the following basic concepts are used.

According to a first concept, a token based mechanism is implemented. Specifically, for example, based on standardized authorization protocol like Oauth 2.0, access tokens are used wherein a communication network control entity, such as a 5GC network element or function, or a RAN element or function, i.e. an entity the UE registers to, first verifies if a requester UE is authorized to receive the service/data being requested. Then, communication network control entity generates an access token and provides it to the requester UE so as to become a consumer. The producer element or function is enabled to validate the access token for the authorization and provision of data

On the other hand, according to a second concept, static/dynamic authorization policies are used. The static/dynamic authorization policies can be directly pushed towards involved UEs, such as the producer UE. The policy allows the producer UE to make an authorization decision. An update mechanism can be included allowing the 5GC to influence the authorization also at a later point of time, e.g. when a request for authorization of an access is received from a requester UE.

It is to be noted that the above concepts can be modified such that the requester and producer entities are part of the same communication network, i.e. a single PLMN is involved, or that the requester entity and the producer entity are parts of different communication networks (e.g. requester UE1 belongs to operator A and producer UE2 belongs to operator B), so that an inter PLMN communication takes place.

That is, in the following, different examples of embodiments will be described for illustrating a processing for conducting authorization processes for a requester UE. To this end, as one example of a communication network to which examples of embodiments may be applied, a communication network architecture based on 3GPP standards for a communication network, such as 5G, is used without restricting the disclosure to such an architecture. It would be apparent to a person skilled in the art that examples of embodiments may also be applied to other kinds of communication networks, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but the principles of described herein can be extended and applied to any other type of communication network, such as a wired communication network as well.

The following examples and embodiments are to be understood only as illustrative examples. Although the text herein may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also comprise features, structures, units, modules etc., that have not been specifically mentioned.

A basic system architecture of a (tele) communication network, including a mobile communication system, where some examples of embodiments are applicable, may include an architecture of one or more communication networks, including wireless or wired access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations (communication elements or communication functions) such as user equipments (UEs), e.g. user devices or terminal devices, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases, and the like, may be included.

The general functions and interconnections of the described elements and functions, which also depend on the actual network type, are understood by those skilled in the art and described in corresponding specifications so that a detailed description thereof is omitted herein. However, it is to be noted that several additional network elements and signaling links may be employed for communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element or network functions, such as a RAN node, a 5GC node like an UDM, a UE, or other network elements or network functions, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are utilized for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted herein that processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. For instance, a “division of labor” between involved network elements, functions or entities may vary case by case.

As used in this application, the term “circuitry” may refer to one or more or all of the

following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Furthermore, as used herein, “at least one of the following:” and “at least one of” and similar wording, where the list of two or more elements are joined by “and” or “or”, mean at least any one of the elements, or at least any two or more of the elements, or at least all the elements.

As indicated above, there are considered two main concepts with corresponding modifications.

In a first concept, which is based on a token based authorization protocol using, for example, Oauth2.0 access tokens, a control network element or function (or control entity), which is e.g. part of a core network element (e.g. UDM) or a RAN element, determines that a consumer UE which requests access to data, such as AIML related data, is authorized to receive corresponding data (e.g. an AI/ML model or related data). Based on the determination, the control entity then generates an access token and provides it to the consumer UE. The consumer UE presents the access token to a producer element or producer function (which is, for example, a producer UE or another network element or function which can provide the requested data) for verification. Based on the verification, the producer element or function (e.g. the producer UE) provides the data, e.g. the model or related data, to the consumer UE.

In one variant of this first concept, it assumed that both the consumer (or requester) UE and the producer element (e.g. the producer UE) are from the same PLMN, wherein the consumer UE is connected to the PLMN (i.e. has an active connection).

In another variant of this first concept, it assumed that the consumer (or requester) UE and the producer element (e.g. the producer UE) are from different PLMNs, wherein the consumer UE is connected to its PLMN (i.e. has an active connection). In this case, a unique temporary ID is used for consumer UE privacy in a direct communication connection to the producer, e.g. in a D2D communication.

As a further variant of this first concept, it assumed that both the consumer UE is not connected to a PLMN (i.e. has no active connection). In this case, the access token can be provided in advance so as to enable the consumer UE to access to the data at the producer without a connection to the PLMN.

In a second concept, which is based on static or dynamic authorization policies which are pushed to the producer elements or functions by a corresponding control network element or function, which is e.g. part of a core network element (e.g. UDM) or a RAN element, a producer element or function (e.g. a producer UE) conducts a processing so as to authorize a request received from a consumer UE, wherein the static or dynamic authorization policies being pushed are used. Based on the determination, the producer element or function provides the requested data (e.g. an AI/ML model or related data) to the consumer UE.

In one variant of the second concept, it assumed that both the consumer (or requester) UE and the producer element (e.g. the producer UE) are from the same PLMN, wherein generic and updated authorization policies are pushed at the UEs (without access tokens).

In another variant of the second concept, it assumed that the consumer (or requester) UE and the producer element (e.g. the producer UE) are from different PLMNs, wherein generic and updated authorization policies are pushed at the UEs (without access tokens). In this case, a unique temporary ID is used for consumer UE privacy in a direct communication connection to the producer, e.g. in a D2D communication.

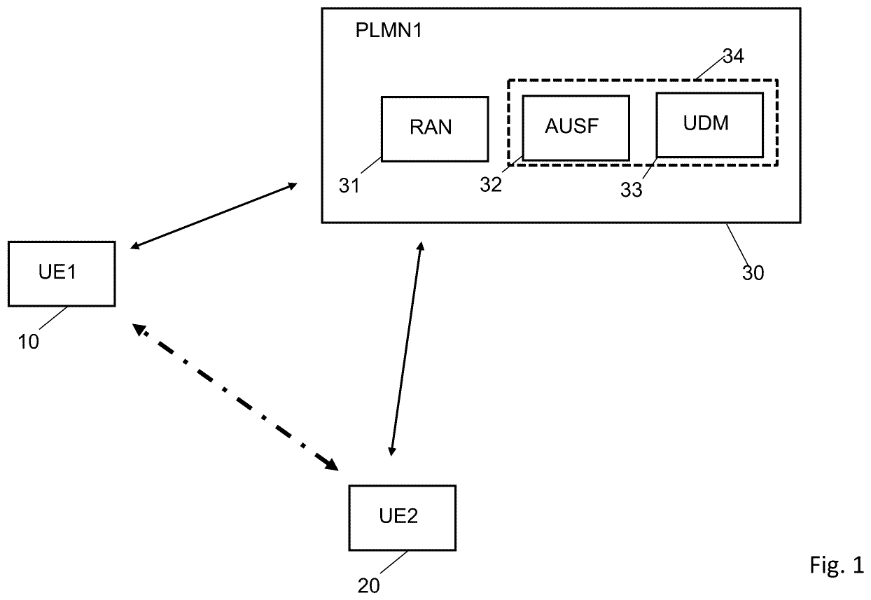

FIG. 1 shows a diagram illustrating an example for a communication scenario according to examples of embodiments. Specifically, FIG. 1 shows an example where the consumer (or requester) UE and the producer element or function (in the example in FIG. 1, it is assumed that the producer element or function is a producer UE) are of the same communication network or PLMN.

Reference sign 10 denotes a UE1 which is the consumer or requester UE in the following example and which requests access to data, such as AIML related data. UE 10 is connected to a PLMN and also configured, for example, to communicate with other UEs via a direct connection, like a D2D connection.

Reference sign 20 denotes a UE2 which is the producer UE in the following example and which possesses the data requested by UE 10, such as AIML related data. UE 20 is also connected to the PLMN and also configured, for example, to communicate with other UEs via a direct connection, like a D2D connection. As indicated above, the producer element or function, which is in the present example the UE 20, can be also another network element or function, e.g. a RAN element or the like.

Reference sign 30 denotes the PLMN1 (i.e. communication network) to which both UEs 10 and 20 belongs. It is to be noted that the PLMN 30 is simplified, for the sake of convenience, wherein only parts are described in the following which are useful for understanding the concepts of embodiments. Other elements or functions besides those indicated in the following can be part of the PLMN, as known to those skilled in the art.

Specifically, the PLMN 30 comprises, amongst other elements, a RAN element 31, such as a gNB, for connection to the UEs 10 and 20. Furthermore, a core network 34 is part of the PLMN 30, which comprises, for example, an authentication server function (AUSF) 32 and a unified data manager function (UDM) 33. The AUSF 32 supports, for example, authentication for 3GPP and non-3GPP access, and is connected with the UDM and an AMF (access and mobility management function) for providing AUSF service. The UDM 33 supports, for example, generation of 3GPP 5G AKA authentication vectors, user identification handling (e.g. storage and management of identification for each subscriber), UE's serving NF registration management (e.g. storing serving AMF for UE), and the like. It is to be noted that the control entity used in following examples for authorization policy related processing resides, for example, in the UDM 33; however, the control entity used for authorization policy related processing as described below can also reside in another network element or function, such as a RAN or 5GC element or function.

As indicated in FIG. 1, the UE1 10 and UE2 20 are connected, e.g. via RAN 31, to the PLMN 30. Furthermore, a direct communication between UE1 10 and UE2 20 can be established, such as a ProSe based connection or D2D connection, as indicated by the dotted arrow in FIG. 1.

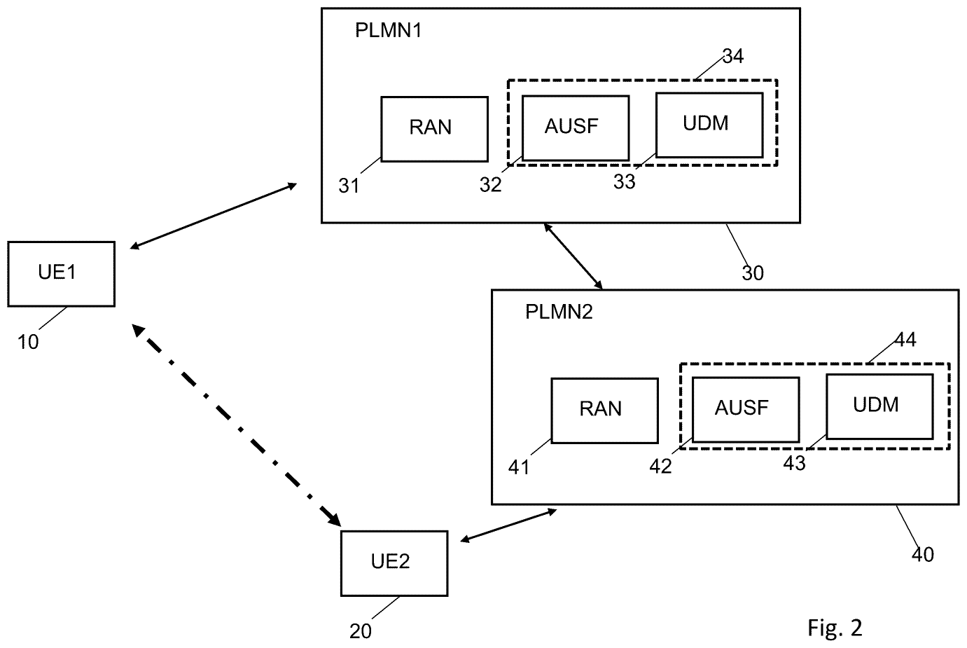

FIG. 2 shows a diagram illustrating another example for a communication scenario according to examples of embodiments. Specifically, FIG. 2 shows an example where the consumer (or requester) UE and the producer element or function (in the example in FIG. 2, it is assumed that the producer element or function is a producer UE) are of different communication networks or PLMNs.

Reference sign 10 denotes a UE1 which is the consumer or requester UE in the following example and which requests access to data, such as AIML related data. UE 10 is connected to a PLMN1 and also configured, for example, to communicate with other UEs via a direct connection, like a D2D connection.

Reference sign 20 denotes a UE2 which is the producer UE in the following example and which possesses the data requested by UE 10, such as AIML related data. UE 20 is connected to a PLMN2 and is also configured, for example, to communicate with other UEs via a direct connection, like a D2D connection. As indicated above, the producer element or function, which is in the present example the UE 20, can be also another network element or function, e.g. a RAN element or the like.

Reference sign 30 denotes the PLMN1 (i.e. communication network) to which UE1 10 is connected. It is to be noted that the PLMN1 30 is simplified, for the sake of convenience, wherein only parts are described in the following which are useful for understanding the concepts of embodiments. Other elements or functions besides those indicated in the following can be part of the PLMN, as known to those skilled in the art.

Specifically, the PLMN1 30 comprises, amongst other elements, a RAN element 31, such as a gNB, for connection to UE1 10. Furthermore, a core network 34 is part of the PLMN1 30, which comprises, for example, an authentication server function (AUSF) 32 and a unified data manager function (UDM) 33. It is to be noted that the control entity used in following examples for authorization policy related processing for UE1 10 resides, for example, in the UDM 33; however, the control entity used for authorization policy related processing as described below can also reside in another network element or function, such as a RAN or 5GC element or function.

Reference sign 40 denotes the PLMN2 (i.e. communication network) to which UE2 20 is connected. It is to be noted that the PLMN2 40 is simplified, for the sake of convenience, wherein only parts are described in the following which are useful for understanding the concepts of embodiments. Other elements or functions besides those indicated in the following can be part of the PLMN, as known to those skilled in the art.

Specifically, the PLMN2 40 comprises, amongst other elements, a RAN element 41, such as a gNB, for connection to UE2 20. Furthermore, a core network 44 is part of the PLMN2 40, which comprises, for example, an authentication server function (AUSF) 42 and a unified data manager function (UDM) 43. It is to be noted that the control entity used in following examples for authorization policy related processing resides, for example, in the UDM 43; however, the control entity used for authorization policy related processing as described below can also reside in another network element or function, such as a RAN or 5GC element or function.

As indicated in FIG. 2, the UE1 10 and UE2 20 are connected, e.g. via RAN 31 and RAN 41, respectively, to the PLMN1 30 and the PLMN2 40. Furthermore, a direct communication between UE1 10 and UE2 20 can be established, such as a ProSe based connection or D2D connection, as indicated by the dotted arrow in FIG. 1. Moreover, a data exchange between the PLMN1 30 and the PLMN2 40 is possible, e.g. via corresponding control entities (like the UDM 32 and the UDM 42) for authorization processing.

In the following, examples of embodiments are described regarding procedures allowing to conduct authorization procedures for allowing to exchange data between a requester UE (i.e. UE1 10) and a producer element or producer function, such as UE2 20, in particular to authorize the requestor UE1 10 to access e.g. AIML related data from producer UE 20.

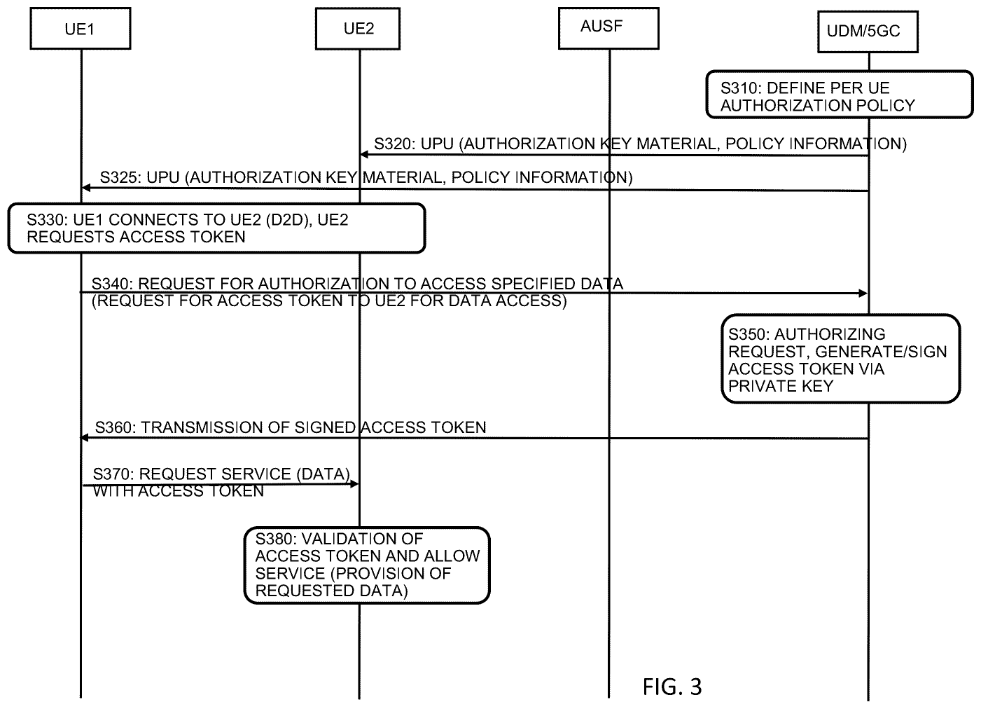

FIGS. 3 to 6 show signaling diagrams illustrating respective examples of authorization control procedures conducted in a communication scenario according to examples of embodiments as described in connection with FIG. 1 and FIG. 2.

In detail, FIG. 3 shows a signaling diagram illustrating an example of an authorization procedure according to examples of embodiments for the variant of the first concept (token based concept) where it assumed that both the consumer (or requester) UE and the producer element (e.g. the producer UE) are from the same PLMN, wherein the consumer UE is connected to the PLMN (i.e. has an active connection).

In S310, the control entity (i.e. the UDM/5GC in this example) defines a per UE authorization policy. That is, for a given kind of data, such as a given model ID, event ID, data topic ID available at a producer element or function (e.g. at the 5GC or RAN or other UE(s)), it is defined which consumer UE is allowed to access the respective kind or data. This is indicated, for example, in form of a predefined UE list, or allowance is related to the area of the UE (e.g. the PLMN to which the requester UE belongs), or it is defined that any UE is allowed to access the data.

For example, it can be defined that access is allowed for model/analytics/data-X, wherein access is allowed for any UE (i.e. allowed UE list=all UE) or for specific UEs (e.g. UEs from PLMN1 only) or UEs in certain area (e.g. a geographic region or the like).

In S320 and S325, the control entity (e.g. the UDM/5GC) sends via a suitable signalling (e.g. NAS, user parameter provisioning (UPU) or other message) to the UEs configuration information. The information includes, for example, key material such as an authorization public key (i.e. key material of the authorization server which generates an access token), which allows to validate the access token, and policy information indicating, for example, that UE to UE connection is allowed, e.g. only after valid token, or that UE to UE connection is allowed without access token.

In S330, the requester UE1 tries to connect to a producer element or function, such as UE2, e.g. over a D2D connection (for the direct connection, technologies like SideLink, Wifi, Bluetooth etc. can be employed). When a connection is initiated, the producer UE2 requests from the UE1 to present an access token for the requested data (e.g. for certain data/analytics or model data).

In S340, UE1 sends an authorization request to the control entity (e.g. the UDM/5GC) for obtaining the allowance to access to the requested data. By means of this request in S340, the UE2 requests resources from the target UE2 which becomes the producer element or function. The request is sent for specific data (e.g. a given model ID/analytics ID, event ID and/or data topic ID), i.e. the type of data which the UE1 wants to get access to is specified. In the present example of embodiments, the request in S340 is for getting an access token.

In S 350, the control entity authorises the request based on operator policy, subscription data of UE2 or the like. Then, the access token is generated by signing the token via an authorization server private key.

According to examples of embodiments, for signing the token, an existing network function, such as a network repository function, can be used. Alternatively, a new authorization server can be created which is for UE to UE authorization. Such an authorization server can be is deployed, for example, in RAN or the core network or in both thereof.

In S360, the control entity sends the signed access token to UE1. According to examples of embodiments, the access token comprises at least one of the following information. An indication of a source of the request, which is e.g. UE1, an indication for the producer element or function defining which UE are allowed, e.g. UE1 or * (for all UE), an indication of the producer PLMN (e.g. xyz), an indication of the connection type, e.g. ProSe, WIFI, and an indication of the kind of data allowed to be accessed, e.g. a model ID/analytics ID/data type ID/event ID.

As indicated above, the token is signed by private key. The public key is configured in the each UE (in S320, S325, for example).

In S370, UE1 sends a service request (i.e. to access to specified data) to UE2 along with the access token received in S360.

In S380, UE2 validates the token via the authorization server public key provisioned in S320. In case the verification is successful, UE2 provides the requested service (e.g. sends the requested data to UE1).

It is to be noted that in an alternative example, UE1 can directly sends the request of S340 to the 5GC in order to request resources (i.e. model/analytics/data type). The control entity in the 5GC (for instance the UDM) first determine whether UE1 requesting for the resources is indeed authorized, and after successful confirmation, the control entity initiates the sending of the requested resource along with the signed access token consisting of the UE ID in the consumer for later use.

Furthermore, in case the requested resource is already available at a neighbourhood UE, then the 5GC can provide in the access token corresponding producer information (e.g. UE specific or list of UE) for indicating the producer. Thus, the consumer UE can only contact and request the resources from the UEs for which the access token is generated. Alternative, the 5GC can provide a generic access token, which is applicable and bound to only the resources being requested, for instance to a specified model ID ‘abc’, a specified analytics ID ‘xyz’, a specified data type ‘123’, or the like. The requester UE can then use this token to request the resource at any neighbourhood UE which possesses that resource.

In summary, according to the above described example, a control entity involved in the authorization procedure conducts the following processing. An authorization policy is defined and configured in UEs wherein the authorization policy specifies what kind of data a consumer UE is allowed to access, for example based on allowed UE list, allowed UEs per area, or any UE allowed. Authorization policy and public key are delivered to UEs, i.e. producer UE2 and consumer UE1. When a request from UE1 comprising a token for connecting to UE2 is received, the request is authorized based on operator policy, and subscription data of UE2. The token is signed with an authorization private key for generating the access token. The signed token is sent to UE1 wherein also a consumer ID (UE1), producer ID (UE2), connection type (e.g., ProSe or WLAN) are included.

Furthermore, according to the above described example, a requester (or consumer) UE involved in the authorization procedure conducts the following processing. The UE receives an authorization policy and a public key. Then, it sends a request to the control entity (e.g. the UDM/5GC) comprising a token for connecting to UE2. Then, the token signed by the control entity is received as the access token. A request to the producer (e.g. UE2) comprising the signed token can then be sent.

On the other hand, according to the above described example, a producer element or function, the a producer UE, involved in the authorization procedure conducts the following processing. It receives an authorization policy and a public key. When it receives a request comprising a token signed by the control entity, e.g. the UDM/5GC, it determines whether the token is valid for the request, and if this is the case, it provides the requested data, such as a requested ML model and/or related data. to the requester UE1.

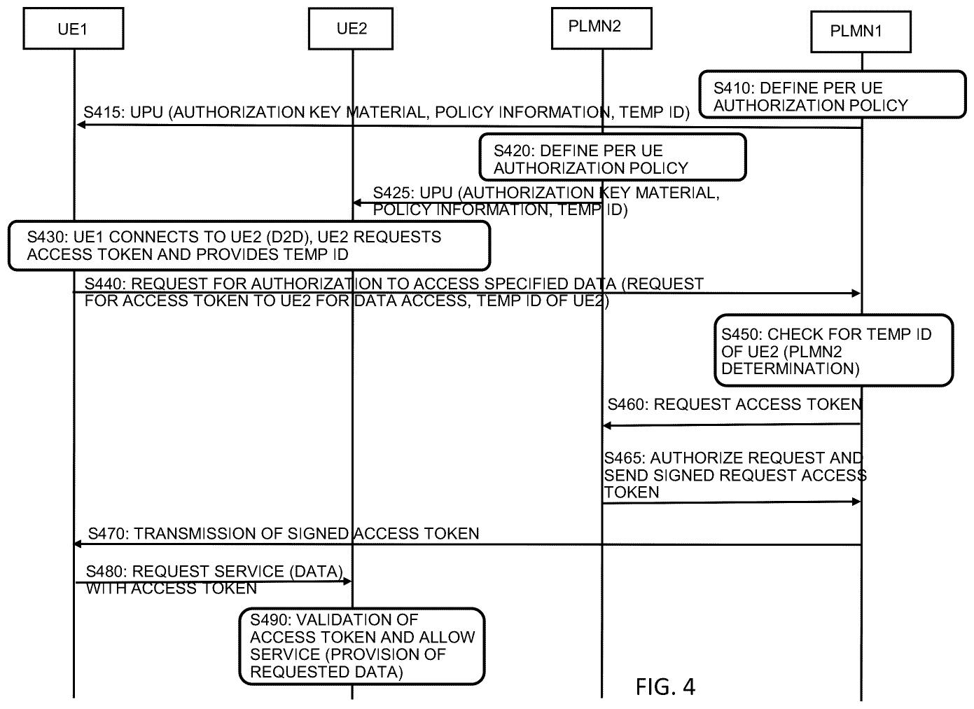

FIG. 4 shows a signaling diagram illustrating an example of an authorization procedure according to examples of embodiments for the variant of the first concept (token based concept) where it assumed that the consumer (or requester) UE and the producer element (e.g. the producer UE) are from different PLMNs, wherein the consumer UE is connected to its PLMN (i.e. has an active connection). In the present example, a temporary ID is used for protecting consumer UE privacy in D2D communication (e.g. ProSe or WLAN) with a producer UE. According to examples of embodiments, the temporary ID is, for example, an AKMA-KID based on 3GPP specification TS 33.535. It is to be noted that WLAN Direct may be used for any WLAN based D2D communication.

In S410 and S420, the respective control entities of PLMN1 and PLMN2 (e.g. the UDM/5GC in this example) define a per UE authorization policy. That is, for a given kind of data, such as a given model ID, event ID, data topic ID available at a producer element or function (e.g. at the 5GC or RAN or other UE(s)), it is defined which consumer UE is allowed to access the respective kind or data. This is indicated, for example, in form of a predefined UE list, or allowance is related to the area of the UE (e.g. the PLMN to which the requester UE belongs), or it is defined that any UE is allowed to access the data. For example, it can be defined that access is allowed for model/analytics/data-X, wherein access is allowed for any UE (i.e. allowed UE list=all UE) or for specific UEs (e.g. UEs from PLMN1 only) or UEs in certain area (e.g. a geographic region or the like).

In S415 and S425, the control entities (e.g. the UDM/5GC) send via a suitable signalling (e.g. NAS, user parameter provisioning (UPU) or other message) to the corresponding UEs configuration information. The information includes, for example, key material such as an authorization public key (i.e. key material of the authorization server which generates an access token), which allows to validate the access token, and policy information indicating, for example, that UE to UE connection is allowed, e.g. only after valid token, or that UE to UE connection is allowed without access token.

Furthermore, the UEs are also configured with temporary ID (e.g. a temporary number). The temporary ID can be generated at the UE or assigned by the PLMN. This temporary ID is unique to the UE and can be used to preserve the privacy at a D2D connection until the time communication is not authorized. The temporary ID is for example the can be an AKMA-KID, or alternatively it is a new temporary number having the following format:
<Temp Number><HPLMN ID>

It is to be noted that the temporary ID can be refreshed after each authentication process.

In S430, the requester UE1 tries to connect to a producer element or function, such as UE2, e.g. over a D2D connection (for the direct connection, technologies like SideLink, Wifi, Bluetooth etc. can be employed). When a connection is initiated, the producer UE2 requests from the UE1 to present an access token for the requested data (e.g. for certain data/analytics or model data). In this context, UE2 shares its temporary ID (obtained in connection with S425, for example) with UE1 (e.g. instead of a MSISDN).

In S440, UE1 sends an authorization request to the control entity (e.g. the UDM/5GC) for obtaining the allowance to access to the requested data. The request includes as information the temporary ID of UE2 received in S430, as well as a source number and information about the data of interest (e.g. model ID/analytics ID etc.). By means of this request in S440, the UE2 requests resources from the target UE2 which becomes the producer element or function. The request is sent for specific data (e.g. a given model ID/analytics ID, event ID and/or data topic ID), i.e. the type of data which the UE1 wants to get access to is specified. In the present example of embodiments, the request in S440 is for getting an access token.

In S450, the control entity of UE1's PLMN (i.e. PLMN1) determines from a check of the request received in S440 that a temporary ID is included which belongs to another PLN (i.e. PLMN2). Therefore, in S460, the control entity of PLMN1 sends an access token request to the control entity of PLMN2. The request in S460 comprises e.g. an indication of the temporary ID, an indication of the source PLMN, information about a source area, and the like, which are required by the control entity of PLMN2 to decide about the authorization of the request coming from UE1.

In S465, the control entity of PLMN2, when it is decided to authorize the request of UE1, signs the token with its private key. Then, the signed access token is sent back to the control entity of PLMN1. According to examples of embodiments, the access token comprises at least one of the following information. An indication of a source of the request, which is e.g. UE1, an indication for the producer element or function defining which UE are allowed, e.g. UE1 or * (for all UE), an indication of the producer PLMN (e.g. xyz), an indication of the connection type, e.g. ProSe, WIFI, and an indication of the kind of data allowed to be accessed, e.g. a model ID/analytics ID/data type ID/event ID.

As indicated above, the token is signed by private key of PLMN2. The public key is configured in each UE (in S415, S425, for example).

In S470, the control entity of PLMN1 sends to UE1 the received access token in response to the request in S440.

Then, in S480, UE1 sends a service request (i.e. to access to specified data) to UE2 along with the access token received in S470.

In S490, UE2 validates the token via the authorization server public key provisioned in S425. In case the verification is successful, UE2 provides the requested service (e.g. sends the requested data to UE1).

In the above described examples, it is assumed that the requester UE1 is connected to the network (i.e. PLMN1) when sending a request to the producer so that an authorization procedure can be executed with the control entity of the PLMN. However, it is also conceivable that the UE1 is not connected to the PLMN when the request is sent to UE2. In this case, the following procedure can be applied.

Specifically, according to examples of embodiments, UE1 can retrieve the access token in advance. The way to obtain the access token can be the same as described in connection with FIGS. 3 and 4, for example. After getting the access token, the access token can be stored on the UE1 side. Due to this, UE1 can use the stored token while connecting to other UEs (e.g. by using a direct connection like D2D, WLAN or ProSe) when UE1 is not connected to network (e.g. out of range or the like)

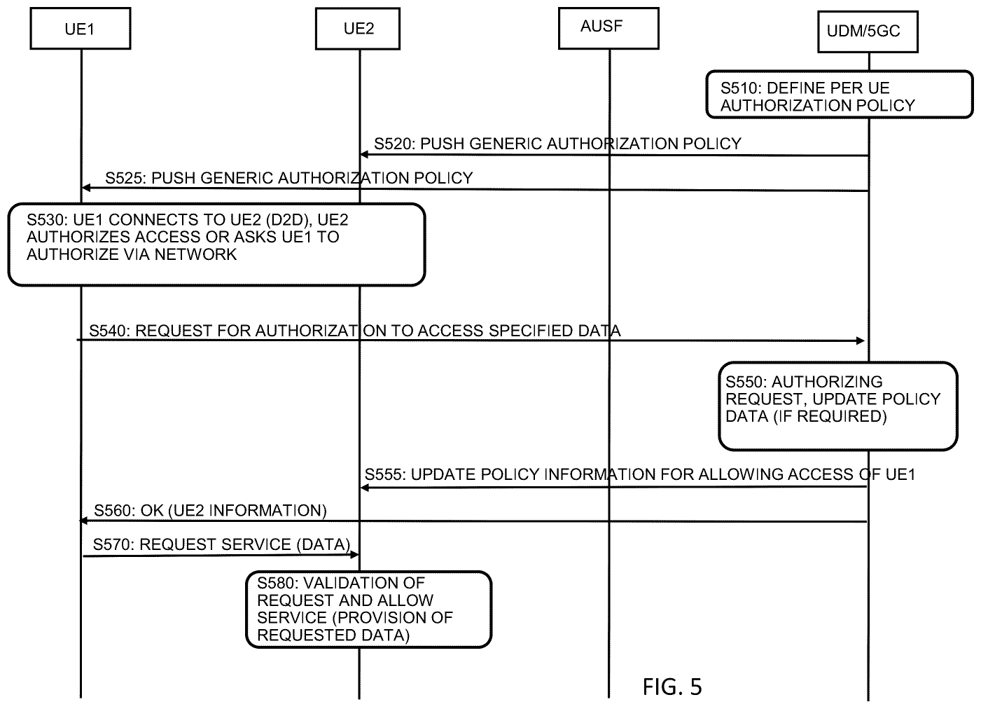

Next, FIG. 5 is described which shows a signaling diagram illustrating an example of an authorization procedure according to examples of embodiments for the variant of the second concept (authorization policy without token) where it assumed that both the consumer (or requester) UE and the producer element (e.g. the producer UE) are from the same PLMN, wherein the consumer UE is connected to the PLMN (i.e. has an active connection). According to examples, authorization policies can be updated at the target UE.

In S510, the control entity (i.e. the UDM/5GC in this example) defines a per UE authorization policy. That is, for a given kind of data, such as a given model ID, event ID, data topic ID available at a producer element or function (e.g. at the 5GC or RAN or other UE(s)), it is defined which consumer UE is allowed to access the respective kind or data. This is indicated, for example, in form of a predefined UE list, or allowance is related to the area of the UE (e.g. the PLMN to which the requester UE belongs), or it is defined that any UE is allowed to access the data.

For example, it can be defined that access is allowed for model/analytics/data-X, wherein access is allowed for any UE (i.e. allowed UE list=all UE) or for specific UEs (e.g. UEs from PLMN1 only) or UEs in certain area (e.g. a geographic region or the like).

In S520 and S525, the control entity (e.g. the UDM/5GC) pushes (e.g. by sending via a suitable signalling (e.g. NAS, user parameter provisioning (UPU) or other message) to the UEs configuration information. The information includes, for example, generic authorization policy information indicating, for example, a model/analytics/data type sharing per PLMN or per geographical area at the UE(s) registered for model training services. Furthermore, information may be included indicating that UE to UE connection is allowed, e.g. only after valid token, or that UE to UE connection is allowed without access token.

In S530, the requester UE1 tries to connect to a producer element or function, such as UE2, e.g. over a D2D connection (for the direct connection, technologies like SideLink, Wifi, Bluetooth etc. can be employed). When a connection is initiated, the producer UE2 processes the request for data from the UE1.

That is, for example, the UE2 determines whether a requested service is to be provided to the UE1 on the basis of the authorization policy information received in S520. If the authorization policy information authorizes UE1 to get the service (e.g. to access to specified data), UE2 can authorize UE1, e.g. based on a static policy available at the UE2. In this case, S580 (described later) can be executed.

On the other hand, in case the authorization policy information do not allow immediate authorization, e.g. UE2 does not have a suitable policy, or when UE2 is configured for a dynamic authorization process for UE1, UE2 asks UE1 to request authorization from network.

In S540, UE1 sends an authorization request to the control entity (e.g. the UDM/5GC) for obtaining the allowance to access to the requested data. The request is sent for specific data (e.g. a given model ID/analytics ID, event ID and/or data topic ID), i.e. the type of data which the UE1 wants to get access to is specified.

In S550, the control entity decides whether the request of UE1 is authorized, based on operator policy, subscription data of UE1 and UE2, or the like. Then, when the authorization request is decided to be allowable, the control entity determines whether the authorization policy configured in the UEs is sufficient or not.

In case it is determined that the authorization policy provided in S520, S525 is not sufficient, the control entity determines changes necessary in the policy setting and updates the authorization policy information in UE2 accordingly in S555. For example, the control entity updates the policy at UE2 with more granular information such as the UE1 ID which is asking for the service, model ID/analytics ID/data type it is authorized for, and the like.

For example, information for the authorization policy being sent comprises indications for a source (UE1), an indication for a producer (UE1), a producer PLMN (e.g. xyz), a connection type (ProSe, WIFI), and/or information about model ID/analytics ID/data type.

After the update in S555, or in case the control entity determines in S550 that the authorization policy configured in the UEs is sufficient, in S560, sends to UE1 an OK message to the request in S540 including information for the UE1 to request data from UE2.

In S570, UE1 sends a service request (i.e. to access to specified data) to UE2.

In S580, UE2 verifies the details of UE1 for allowing access to data on the basis of the authorization policy information received in S520 or in S555. In case the verification is successful, UE2 provides the requested service (e.g. sends the requested data to UE1).

In summary, according to the above described example, a control entity involved in the authorization procedure conducts the following processing. An authorization policy is configured, specifying what kind of data is a consumer UE allowed to access, for example based on allowed UE list, allowed UEs per area, or any UE allowed. Generic authorization policy is pushed to producer UE2, e.g. based on types of ML models and/or related data allowed to be shared per PLMN or geographical area. Furthermore, generic authorization policy is pushed to consumer UE1. When a request to access specific ML model or related data is received, authorization of the request is decided based on authorization policy and subscription data of UE1 and UE2. If required, an updated policy is pushed to UE2 in response to determining that the generic authorization policy is not sufficient for the request. UE1 is provided with information to request the ML model or data from UE2.

Furthermore, according to the above described example, a consumer (or requester) UE involved in the authorization procedure conducts the following processing. Generic authorization policy information is received. A request is sent to the control entity (e.g. the UDM/5GC/RAN) for accessing an ML model or related data. Information are received usable for sending a request to UE2. A corresponding request is sent to UE2 for accessing the ML model or related data.

On the other hand, according to the above described example, a producer element or function, such as a producer UE2 involved in the authorization procedure conducts the following processing. Generic authorization policy information is received. Furthermore, an updated policy may be received, if sent by the control entity. Requested ML model or related data are sent to the UE1 after determining, based on the pushed at least one authorization policy and details of UE1, that the request is valid for UE1.

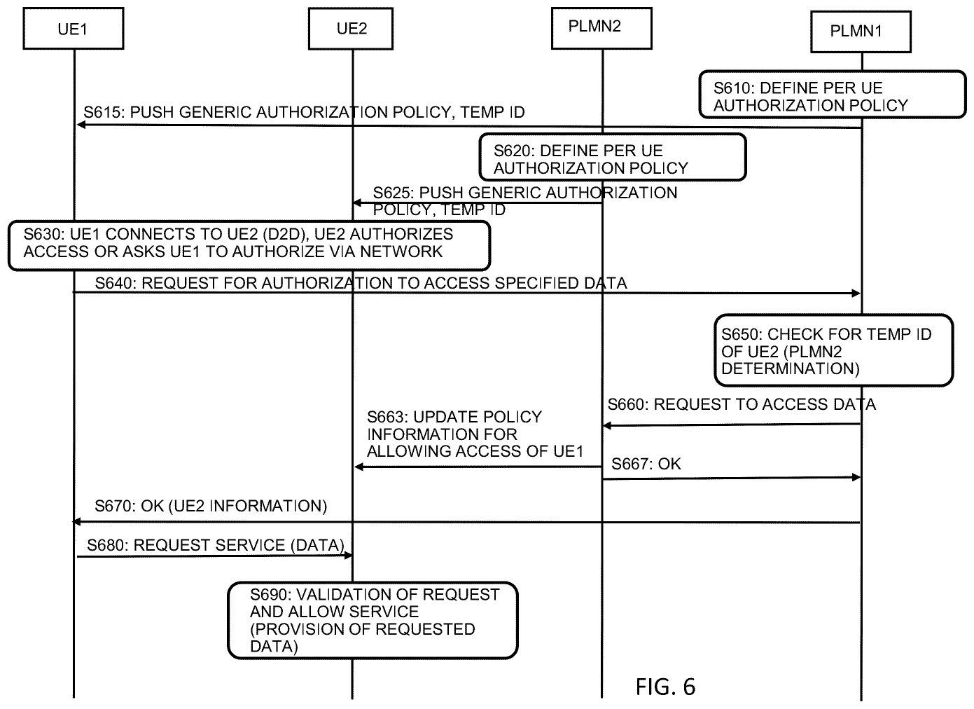

FIG. 6 shows a signaling diagram illustrating an example of an authorization procedure according to examples of embodiments for the variant of the second concept (generic authorization policy without token) where it assumed that the consumer (or requester) UE and the producer element (e.g. the producer UE) are from different PLMNs, wherein the consumer UE is connected to its PLMN (i.e. has an active connection). In the present example, a temporary ID is used for protecting consumer UE privacy in D2D communication (e.g. ProSe or WLAN) with a producer UE. According to examples of embodiments, the temporary ID is, for example, an AKMA-KID based on 3GPP specification TS 33.535. It is to be noted that WLAN Direct may be used for any WLAN based D2D communication. In this example, due to inter-PLMN communication, the PLMN1 of the requester UE asks for authorization on behalf of UE1 at the PLMN2 of the producer UE2. Moreover, according to examples, authorization policies can be updated at the target UE.

In S610 and S620, the respective control entities of PLMN1 and PLMN2 (e.g. the UDM/5GC in this example) define a per UE authorization policy. That is, for a given kind of data, such as a given model ID, event ID, data topic ID available at a producer element or function (e.g. at the 5GC or RAN or other UE(s)), it is defined which consumer UE is allowed to access the respective kind or data. This is indicated, for example, in form of a predefined UE list, or allowance is related to the area of the UE (e.g. the PLMN to which the requester UE belongs), or it is defined that any UE is allowed to access the data. For example, it can be defined that access is allowed for model/analytics/data-X, wherein access is allowed for any UE (i.e. allowed UE list=all UE) or for specific UEs (e.g. UEs from PLMN1 only) or UEs in certain area (e.g. a geographic region or the like).

In S615 and S625, the control entities (e.g. the UDM/5GC) push (e.g. by sending via a suitable signalling (e.g. NAS, user parameter provisioning (UPU) or other message) to the UEs configuration information. The information includes, for example, generic authorization policy information indicating, for example, a model/analytics/data type sharing per PLMN or per geographical area at the UE(s) registered for model training services. Furthermore, information may be included indicating that UE to UE connection is allowed, e.g. only after valid token, or that UE to UE connection is allowed without access token.

Furthermore, the UEs are also configured with temporary ID (e.g. a temporary number). The temporary ID can be generated at the respective UE or assigned by the corresponding PLMN. This temporary ID is unique to each UE and can be used to preserve the privacy at a D2D connection until the time communication is not authorized. The temporary ID is for example the can be an AKMA-KID, or alternatively it is a new temporary number having the following format:
<Temp Number><HPLMN ID>

It is to be noted that the temporary ID can be refreshed after each authentication process.

In 630, the requester UE1 tries to connect to a producer element or function, such as UE2, e.g. over a D2D connection (for the direct connection, technologies like SideLink, Wifi, Bluetooth etc. can be employed). When a connection is initiated, the producer UE2 processes the request for data from the UE1. Furthermore, when a connection is initiated, the producer UE2 shares its temporary ID (obtained in connection with S625, for example) with UE1 (e.g. instead of a MSISDN).

In the processing, the UE2 determines whether a requested service is to be provided to the UE1 on the basis of the authorization policy information received in S625. If the authorization policy information authorizes UE1 to get the service (e.g. to access to specified data), UE2 can authorize UE1, e.g. based on a static policy available at the UE2. In this case, S690 (described later) can be executed.

On the other hand, in case the authorization policy information does not allow immediate authorization, e.g. UE2 does not have a suitable policy, or when UE2 is configured for a dynamic authorization process for UE1, UE2 asks UE1 to request authorization from network.

In S640, UE1 sends an authorization request to the control entity (e.g. the UDM/5GC) for obtaining the allowance to access to the requested data. The request is sent for specific data (e.g. a given model ID/analytics ID, event ID and/or data topic ID), i.e. the type of data which the UE1 wants to get access to is specified. In addition, the request includes as information the temporary ID of UE2 received in S630, as well as a source number and information about the data of interest (e.g. model ID/analytics ID etc.). By means of this request in S440, the UE2 requests resources from the target UE2 which becomes the producer element or function. The request is sent for specific data (e.g. a given model ID/analytics ID, event ID and/or data topic ID), i.e. the type of data which the UE1 wants to get access to is specified.

In S650, the control entity of UE1's PLMN (i.e. PLMN1) determines from a check of the request received in S640 that a temporary ID is included which belongs to another PLN (i.e. PLMN2). Therefore, in S660, the control entity of PLMN1 sends a request for allowing access of UE1 to data from UE2 to the control entity of PLMN2. The request in S660 comprises e.g. an indication of the temporary ID, an indication of the source PLMN, information about a source area, and the like, which are required by the control entity of PLMN2 to decide about the authorization of the request coming from UE1.

The control entity of PLMN2 decides to authorize the request of UE1. In this context, the control entity of PLMN2 also determines whether the authorization policy configured in the UE2 is sufficient or not.

In case it is determined that the authorization policy provided in S625 is not sufficient, the control entity determines changes necessary in the policy setting and updates the authorization policy information in UE2 accordingly in S663. For example, the control entity updates the policy at UE2 with more granular information such as the UE1 ID which is asking for the service, model ID/analytics ID/data type it is authorized for, and the like.

For example, information for the authorization policy being sent comprises indications for a source (UE1), an indication for a producer (UE1), a producer PLMN (e.g. xyz), a connection type (ProSe, WIFI), and/or information about model ID/analytics ID/data type.

After the update in S663, or in case the control entity determines that the authorization policy configured in the UE2 is sufficient, in S667, the control entity of PLMN2 sends to the control entity of PLMN1 an OK message to the request in S660.

Then, in S670, the control entity of PLMN1 sends to UE1 an OK message to the request in S640 including information for the UE1 to request data from UE2 Then, in S680, UE1 sends a service request (i.e. to access to specified data) to UE2.

In S690, UE2 verifies the details of UE1 for allowing access to data on the basis of the authorization policy information received in S625 or in S663. In case the verification is successful, UE2 provides the requested service (e.g. sends the requested data to UE1).

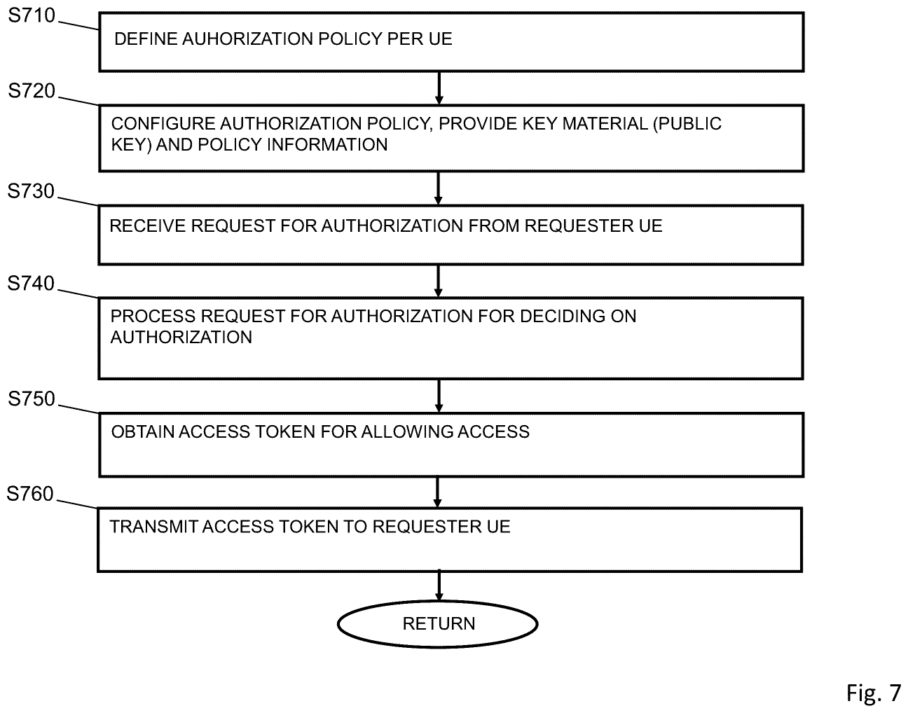

FIG. 7 shows a flow chart of a processing conducted in a control entity, such as a 5GC network element or function, a RAN element or function, or a UDM, which conducts an authorization procedure as a control entity according to some examples of the embodiments, as described in connection with FIGS. 3 and 4. That is, FIG. 7 shows a flowchart related to a processing conducted by a control entity of PLMN1 or PLMN2 of FIG. 1 or FIG. 2. The control entity can comprise or be comprised in one of a core network control element or core network control function, an access network control element or access network control function. For example, the control entity comprises or is comprised in a UDM entity.

In S710, an authorization policy per UE is defined in the control entity. The authorization policy generally indicates which data are allowed to be accessed by which user equipment, for example.

In S720, authorization policy is configured to one or more UEs (e.g. UE1 and UE2) by providing a key material usable for validating an access token and information regarding the authorization policy. The information indicates an allowance for connection between a requester UE and a producer element or a producer function (e.g. UE2) with a valid access token or without an access token.

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

Specifically, according to some examples of embodiments, the data indicated in the authorization policy comprises at least one or more of the following: an AIML model ID, an AIML event ID, or a data topic ID. The UEs allowed to access the data are identified by at least one of the following: a predefined list of UEs, an indication of a specified area where a UE is located (e.g. geographical area), an indication of a communication network (PLMN) to which a UE belongs, or an indication that any UE is allowed.

According to examples of embodiments, the key material and the information regarding the authorization policy can be provided by using one of a NAS signaling or a user parameter provisioning (UPU) signaling for a transmission to the one or more UEs.

In S730, the control entity receives a request for authorization of a requester UE (e.g. UE1) to access to specified data from a producer element or producer function (e.g. the UE2).

According to examples of embodiments, the specified data indicated in the request for authorization of the requester UE include at least one of the following: AIML model data, AIML training data, or AIML analysis data.

Moreover, according to examples of embodiments, the request for authorization of the requester user equipment includes an identification of a producer element or producer function.

Furthermore, according to examples of embodiments, the request for authorization of the requester UE is received from one of the requester UE (corresponding to FIG. 3, i.e. the control entity is located in PLMN 1) or from a control network element or control network function of another communication network (corresponding to FIG. 4, i.e. the control entity is located in PLMN 2).

In S740, the request for authorization of the requester UE is processed for deciding whether the request is allowed.

According to examples of embodiments, when the request for authorization of the requester UE is processed, it is decided whether the request is allowed or not on the basis of an operator policy and subscription data of the producer element or producer function.

In S750, in case the request is allowed, an access token for allowing access to the specified data from the producer element or producer function is obtained.

According to examples of embodiments, the access token comprises at least one of the following: an identification of a source UE of the request, an identification of a producer element or producer function of the requested data, an identification of a communication network where the producer element or producer function of the requested data is located, or an indication of a connection type to be used for obtaining the requested data from the producer element or producer function.

Furthermore, according to examples of embodiments, the access token is signed by a private key, wherein the key material is a corresponding public key used to validate the access token at the producer element or producer function.

In S760, the obtained access token to the requester UE.

In this connection, according to examples of embodiments, with the access token transmitted to the requester UE, information is provided which indicates at least one the following: information identifying at least one producer element or producer function for prompting the requester UE to contact only an identified producer element or producer function as a target for requesting the specified data, or information is provided indicating specified resources of data for prompting the requester UE to request only the indicated resources from a suitable producer element or producer function. In this case, the access token is a generic access token.

According to examples of embodiments, when the processing of the request for authorization of the requester UE is decided to be allowed, the access token for allowing access to the specified data from the producer element or producer function is generated by the control entity, wherein the generated access token is transmitted to the requester UE.

On the other hand, according to examples of embodiments, when the request for authorization of the requester UE is received, it is also checked whether a unique temporary ID for the producer element or producer function is included in the request, wherein this unique temporary ID indicates a relation to another communication network (e.g. PLMN2), as described in connection with FIG. 4, for example. In case the determination is affirmative, the request for authorization of the requester UE is forwarded to a control network element or control network function (i.e. corresponding control entity) of the other communication network (PLMN2) for obtaining the access token. When the access token is received from the control network element or control network function of the other communication network, the received access token is transmitted to the requester user equipment (described later).

According to examples of embodiments, the unique temporary identifier is configured in the producer element or producer function by a control network element or control network function of the corresponding PLMN, or it is generated by the producer element or producer function itself.

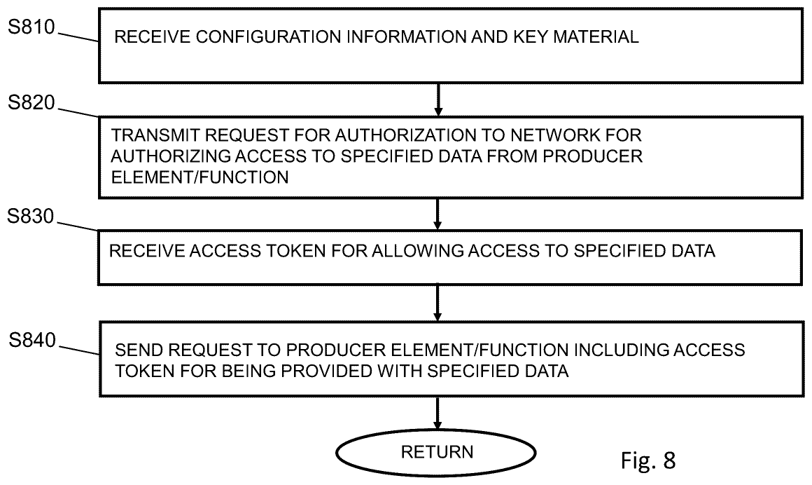

FIG. 8 shows a flow chart of a processing conducted in requester UE, such as UE1, which conducts an authorization procedure according to some examples of the embodiments, as described in connection with FIGS. 3 and 4. That is, FIG. 8 shows a flowchart related to a processing conducted by a requester UE of PLMN1 of FIG. 1 or FIG. 2.

In S810, configuration information regarding an authorization policy is received from a control network element or control network function. The information includes key material usable for validating an access token and information indicating an allowance for connection between a requester UE and a producer element or a producer function with a valid access token or without an access token.

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

According to examples of embodiments, the key material and the information regarding the authorization policy can be received via one of a NAS signaling or a user parameter provisioning (UPU) signaling for a transmission to the one or more UEs.

In S820, a request for authorization to access to specified data from a producer element or producer function is sent to the control network element or control network function (i.e. the control entity of PLMN1, for example).

According to examples of embodiments, the producer element or producer function indicated in the request for authorization to access to the specified data is one of a producer UE or a producer communication network element or producer communication network function (e.g. RAN or 5GC, or the like).

Furthermore, according to examples of embodiments, the specified data indicated in the request for authorization of the requester UE include at least one of the following: AIML model data, AIML training data, or AIML analysis data.

Moreover, according to examples of embodiments, the request for authorization includes an identification of a producer element or producer function.

According to examples of embodiments, the request for authorization to access to specified data is transmitted to the control entity after receiving an inquiry from the producer element or producer function to present the access token, which is received e.g. after contacting the producer element or producer function.

In S830, in response to the request for authorization, the requester UE receives an access token for allowing access to the specified data from the producer element or producer function.

According to examples of embodiments, the access token received from the control entity comprises information indicating at least one the following: information identifying at least one producer element or producer function for prompting to contact only an identified producer element or producer function as a target for requesting the specified data, or information indicating specified resources of data for prompting to request only the indicated resources from a suitable producer element or producer function. In this case, wherein the access token is a generic access token.

Moreover, according to examples of embodiments, the access token comprises at least one of the following: an ID of a source UE of the request, an ID of a producer element or producer function of the requested data, an ID of a communication network where the producer element or producer function of the requested data is located, or an indication of a connection type to be used for obtaining the requested data from the producer element or producer function.

According to examples of embodiments, the access token is signed by a private key, wherein the key material is a corresponding public key used to validate the access token at the producer element or producer function.

In S840, the requester UE sends a request to the producer element or producer function for being provided with the specified data. In the request, the received access token is included.

According to examples of embodiments, in response to the request in S840, the requested specified data are received from the producer element or producer function.

According to further examples of embodiments, as described in connection with FIG. 4, a unique temporary ID is obtained which is assigned for preserving privacy in a D2D communication. The unique temporary ID is received from the control entity, or is generated in the requester UE. The unique temporary ID is indicated in the request for authorization to access the specified data available at the producer element or producer function identified by unique temporary identifier.

Furthermore, according to examples of embodiments, as described in connection with FIG. 4, the requester UE receives from a producer element or producer function from which specified data are to be obtained, a unique temporary ID of the producer element or producer function assigned for preserving privacy in a D2D communication. This unique temporary ID is indicated as an identification of the producer element or producer function in the request for authorization to access the specified data being sent in S820.

Furthermore, according to examples of embodiments, it is also possible that the requester UE stores the received access token for later use, e.g. when the UE is not connected to the PLMN.

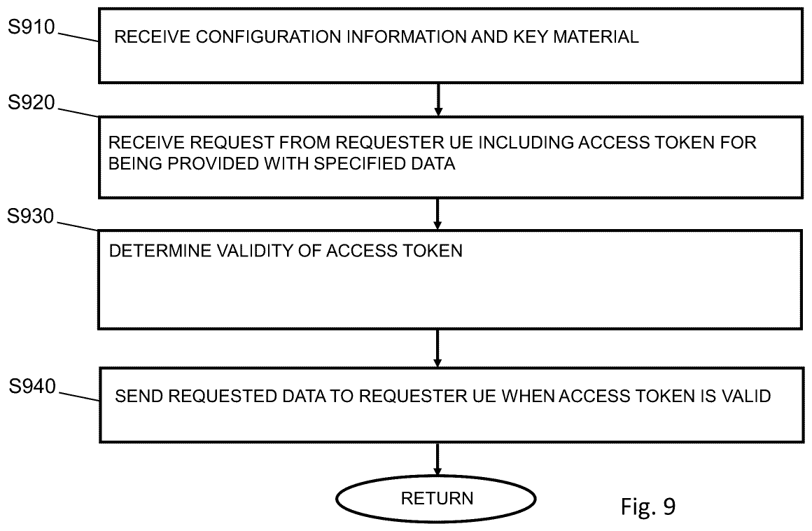

FIG. 9 shows a flow chart of a processing conducted in producer element or producer function, i.e. a producer UE like UE2 or a producer communication network element or a producer communication network function such as a RAN or 5GC element or function, which conducts an authorization procedure according to some examples of the embodiments, as described in connection with FIGS. 3 and 4. That is, FIG. 9 shows a flowchart related to a processing conducted by a producer UE2 of PLMN1 or PLMN 2 of FIG. 1 or FIG. 2.

In S910, configuration information regarding an authorization policy is received from a control network element or control network function. The information includes key material usable for validating an access token and information indicating an allowance for connection between a requester UE and a producer element or a producer function with a valid access token or without an access token.

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

According to examples of embodiments, the key material and the information regarding the authorization policy can be received via one of a NAS signaling or a user parameter provisioning (UPU) signaling for a transmission to the one or more UEs.

In S920, a request for specified data to be provided from a producer element or producer function is received from a requester UE (e.g. UE1), wherein the request comprises an access token for allowing access to the specified data from the producer element or producer function.

According to examples of embodiments, the specified data indicated in the request for authorization of the requester UE include at least one of the following: AIML model data, AIML training data, or AIML analysis data.

Moreover, according to examples of embodiments, the access token comprises at least one of the following: an ID of a source UE of the request, an ID of a producer element or producer function of the requested data, an ID of a communication network where the producer element or producer function of the requested data is located, or an indication of a connection type to be used for obtaining the requested data from the producer element or producer function.

According to examples of embodiments, the access token is signed by a private key, wherein the key material is a corresponding public key used to validate the access token at the producer element or producer function.

In S930, a validity of the received access token is determined. This is based, for example on the key material received in S910.

In S940, if the validity of the access token is confirmed, the requested specified data are sent to the requester UE.

According to further examples of embodiments, as described in connection with FIG. 4, a unique temporary ID is obtained which is assigned for preserving privacy in a D2D communication. The unique temporary ID is received from the control entity, or is generated in the producer element or producer function. The unique temporary ID is indicated to a requestor UE trying to access specified data.

Furthermore, according to examples of embodiments, an inquiry is transmitted to a requester UE to present an access token.

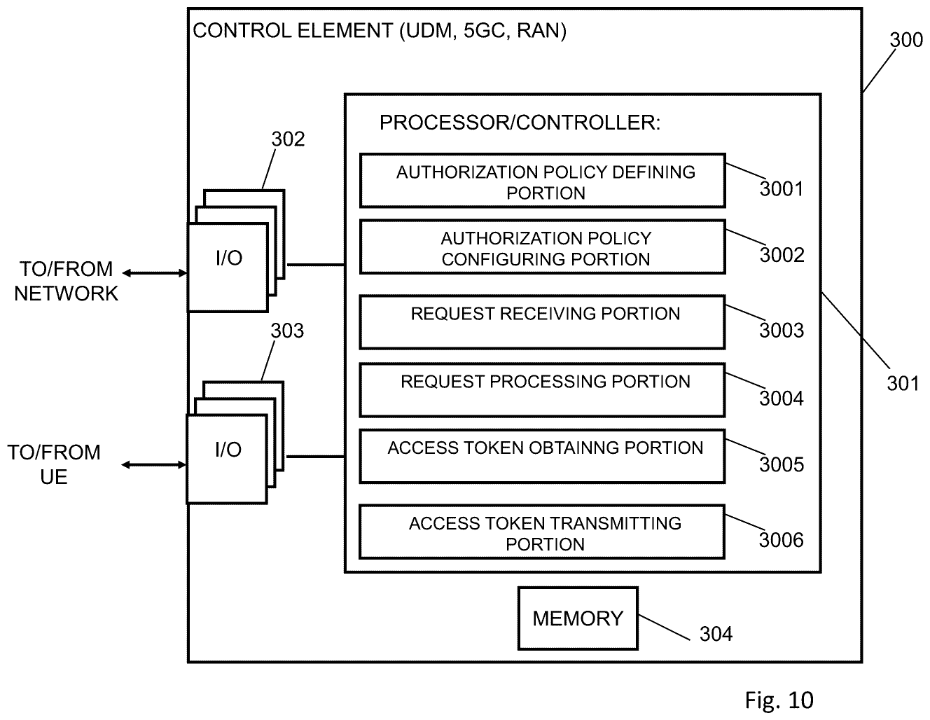

FIG. 10 shows a diagram of a network element or network function 300, such as a 5GC network element or function, a RAN element or function, or a UDM, which conducts an authorization procedure as a control entity according to some examples of the embodiments, as described in connection with FIGS. 3 and 4. It is to be noted that the network element or function 300, such as the UDM as the control entity, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The control entity 300 shown in FIG. 10 may include a processing circuitry, a processing function, a control unit or a processor 301, such as a CPU or the like, which is suitable for executing instructions given by programs or the like related to the control procedure. The processor 301 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 302 and 303 denote input/output (I/O) units or functions (interfaces) connected to the processor or processing function 301. The I/O units 302 may be used for communicating with a network part. The I/O units 303 may be used for communicating with a UE, such as the UE1 or UE2. The I/O units 302 and 303 may be combined units including communication equipment towards several entities, or may include a distributed structure with a plurality of different interfaces for different entities. Reference sign 304 denotes a memory usable, for example, for storing data and programs to be executed by the processor or processing function 301 and/or as a working storage of the processor or processing function 301. It is to be noted that the memory 304 may be implemented by using one or more memory portions of the same or different type of memory.

The processor or processing function 301 is configured to execute processing related to the above described authorization procedure. In particular, the processor or processing circuitry or function 301 includes one or more of the following sub-portions. Sub-portion 3001 is a processing portion which is usable as a portion for defining an authorization policy. The portion 3001 may be configured to perform processing according to S710 of FIG. 7. Furthermore, the processor or processing circuitry or function 301 may include a sub-portion 3002 usable as a portion for configuring an authorization policy. The portion 3002 may be configured to perform a processing according to S720 of FIG. 7. In addition, the processor or processing circuitry or function 301 may include a sub-portion 3003 usable as a portion for receiving a request. The portion 3003 may be configured to perform a processing according to S730 of FIG. 7. Furthermore, the processor or processing circuitry or function 301 may include a sub-portion 3004 usable as a portion for processing a request. The portion 3004 may be configured to perform a processing according to S740 of FIG. 7. Moreover, the processor or processing circuitry or function 301 may include a sub-portion 3005 usable as a portion for obtaining an access token. The portion 3005 may be configured to perform a processing according to S750 of FIG. 7. In addition, the processor or processing circuitry or function 301 may include a sub-portion 3006 usable as a portion for transmitting an access token. The portion 3006 may be configured to perform a processing according to S760 of FIG. 7.

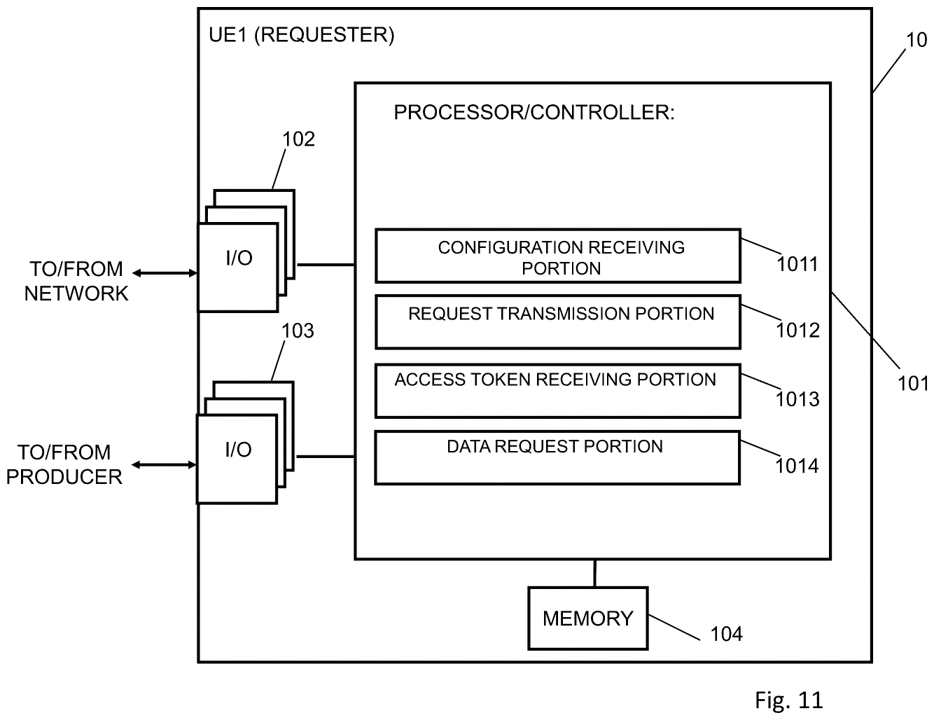

FIG. 11 shows a diagram of a network element or network function 10, such as UE1, which conducts an authorization procedure as a requester UE according to some examples of the embodiments, as described in connection with FIGS. 3 and 4. It is to be noted that the network element or function 10, such as the UE1, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The requester UE1 10 shown in FIG. 11 may include a processing circuitry, a processing function, a control unit or a processor 101, such as a CPU or the like, which is suitable for executing instructions given by programs or the like related to the control procedure. The processor 101 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 102 and 103 denote input/output (I/O) units or functions (interfaces) connected to the processor or processing function 101. The I/O units 102 may be used for communicating with a communication network, such as PLMN1. The I/O units 103 may be used for directly communicating with another UE, such as the UE2 via D2D or the like. The I/O units 102 and 103 may be combined units including communication equipment towards several entities, or may include a distributed structure with a plurality of different interfaces for different entities. Reference sign 104 denotes a memory usable, for example, for storing data and programs to be executed by the processor or processing function 101 and/or as a working storage of the processor or processing function 101. It is to be noted that the memory 104 may be implemented by using one or more memory portions of the same or different type of memory.

The processor or processing function 101 is configured to execute processing related to the above described authorization procedure. In particular, the processor or processing circuitry or function 101 includes one or more of the following sub-portions. Sub-portion 1011 is a processing portion which is usable as a portion for receiving configuration information. The portion 1011 may be configured to perform processing according to S810 of FIG. 8. Furthermore, the processor or processing circuitry or function 101 may include a sub-portion 1012 usable as a portion for transmitting a request. The portion 1012 may be configured to perform a processing according to S820 of FIG. 8. In addition, the processor or processing circuitry or function 101 may include a sub-portion 1013 usable as a portion for receiving an access token. The portion 1013 may be configured to perform a processing according to S830 of FIG. 8. Furthermore, the processor or processing circuitry or function 101 may include a sub-portion 1014 usable as a portion for requesting data. The portion 1014 may be configured to perform a processing according to S840 of FIG. 8.

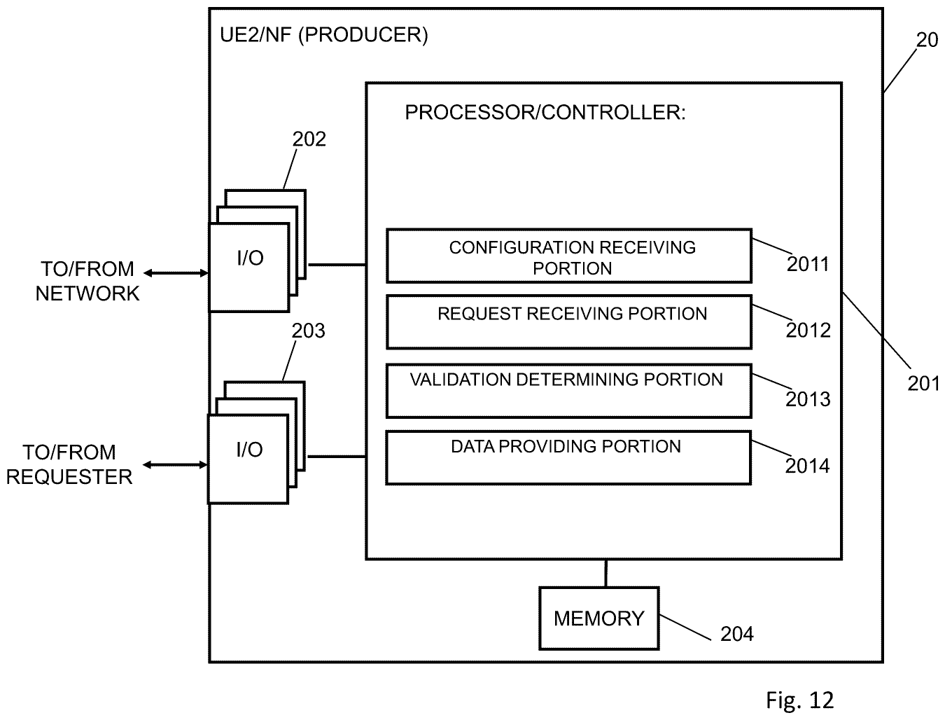

FIG. 12 shows a diagram of a network element or network function 20, such as UE2, which conducts an authorization procedure as a producer element or function according to some examples of the embodiments, as described in connection with FIGS. 3 and 4. It is to be noted that the network element or function 20, such as the UE2, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The producer UE2 20 shown in FIG. 12 may include a processing circuitry, a processing function, a control unit or a processor 201, such as a CPU or the like, which is suitable for executing instructions given by programs or the like related to the control procedure. The processor 201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 202 and 203 denote input/output (I/O) units or functions (interfaces) connected to the processor or processing function 201. The I/O units 202 may be used for communicating with a communication network, such as PLMN1 or PLMN2. The I/O units 203 may be used for directly communicating with another UE, such as the UE1 via D2D or the like. The I/O units 202 and 203 may be combined units including communication equipment towards several entities, or may include a distributed structure with a plurality of different interfaces for different entities. Reference sign 204 denotes a memory usable, for example, for storing data and programs to be executed by the processor or processing function 201 and/or as a working storage of the processor or processing function 201. It is to be noted that the memory 204 may be implemented by using one or more memory portions of the same or different type of memory.

The processor or processing function 201 is configured to execute processing related to the above described authorization procedure. In particular, the processor or processing circuitry or function 201 includes one or more of the following sub-portions. Sub-portion 2011 is a processing portion which is usable as a portion for receiving configuration information. The portion 2011 may be configured to perform processing according to S910 of FIG. 9. Furthermore, the processor or processing circuitry or function 201 may include a sub-portion 2012 usable as a portion for receiving a request. The portion 2012 may be configured to perform a processing according to S920 of FIG. 9. In addition, the processor or processing circuitry or function 201 may include a sub-portion 2013 usable as a portion for determination a validation. The portion 2013 may be configured to perform a processing according to S930 of FIG. 9. Furthermore, the processor or processing circuitry or function 201 may include a sub-portion 2014 usable as a portion for providing data. The portion 2014 may be configured to perform a processing according to S940 of FIG. 9.

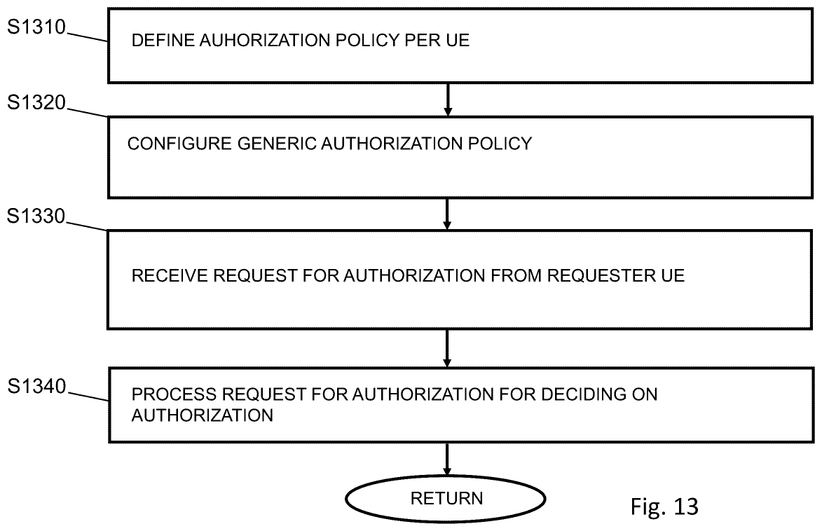

FIG. 13 shows a flow chart of a processing conducted in control entity, such as a 5GC network element or function, a RAN element or function, or a UDM, which conducts an authorization procedure as a control entity according to some examples of the embodiments, as described in connection with FIGS. 5 and 6. That is, FIG. 13 shows a flowchart related to a processing conducted by a control entity of PLMN1 or PLMN2 of FIG. 1 or FIG. 2. The control entity can comprise or be comprised in one of a core network control element or core network control function, an access network control element or access network control function. For example, the control entity comprises or is comprised in a UDM entity.

In S1310, an authorization policy per UE is defined in the control entity. The authorization policy generally indicates which data are allowed to be accessed by which user equipment, for example.

In S1320, authorization policy is configured to one or more UEs (e.g. UE1 and UE2) by pushing authorization policy information to a network element or network function and to one or more user equipments (i.e. to at least producer elements or producer functions, like UE2). The information indicates an allowance for connection between a requester UE and a producer element or a producer function (e.g. UE2) with a valid access token or without an access token.

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

Specifically, according to some examples of embodiments, the data indicated in the authorization policy comprises at least one or more of the following: an AIML model ID, an AIML event ID, or a data topic ID. The UEs allowed to access the data are identified by at least one of the following: a predefined list of UEs, an indication of a specified area where a UE is located (e.g. geographical area), an indication of a communication network (PLMN) to which a UE belongs, or an indication that any UE is allowed.

In S1330, the control entity receives a request for authorization of a requester UE to access to specified data from a producer element or producer function.

According to examples of embodiments, the specified data indicated in the request for authorization of the requester UE include at least one of the following: AIML model data, AIML training data, or AIML analysis data.

Furthermore, according to examples of embodiments, the request for authorization of the requester UE is received from one of the requester UE (corresponding to FIG. 5, i.e. the control entity is located in PLMN 1) or from a control network element or control network function of another communication network (corresponding to FIG. 6, i.e. the control entity is located in PLMN 2).

In S1340, the request for authorization of the requester UE is processed for deciding whether the request is allowed.

According to examples of embodiments, when processing the request for authorization of the requester UE, it is decided whether the request is allowed or not on the basis of an operator policy and subscription data of the producer element or producer function.

Moreover, according to examples of embodiments, in case the request is allowed, the requester UE is authorized, e.g. by sending a corresponding OK indication, to access the specified data from the producer element or producer function.

In this connection, according to examples of embodiments, information related to the producer element or producer function (e.g. UE2) is provided together with the indication of the authorization.

Furthermore, according to examples of embodiments, it is checked whether the authorization policy information pushed to a network element, a network function or a user equipment being the producer element or producer function is sufficient for the specified data being indicated in the request for authorization. In case it is determined that the authorization policy information pushed to the network element, the network function or the user equipment being the producer element or producer function is not sufficient for the specified data, an update process is conducted in which the authorization policy information in the network element, the a network function or the user equipment being the producer element or producer function is updated so as to be able to handle the request for specified data.

According to examples of embodiments, the authorization policy information comprises at least one of the following: an ID of a source UE of the request, an ID of a producer element or producer function of the requested data, an ID of a communication network where the producer element or producer function of the requested data is located, or an indication of a connection type to be used for obtaining the requested data from the producer element or producer function.

Moreover, according to examples of embodiments, when the request for authorization of the requester UE is received, it is checked whether a unique temporary ID for the producer element or producer function is included in the request, wherein this unique temporary ID indicates a relation to another communication network (e.g. PLMN2), as described in connection with FIG. 6, for example. In case the determination is affirmative, the request for authorization of the requester UE is forwarded to a control network element or control network function (i.e. corresponding control entity) of the other communication network (PLMN2) for obtaining the access token. When the access is allowed by the control network element or control network function of the other communication network, the allowance is indicated to the requester UE.

According to examples of embodiments, the unique temporary identifier is configured in the producer element or producer function by a control network element or control network function of the corresponding PLMN, or it is generated by the producer element or producer function itself.

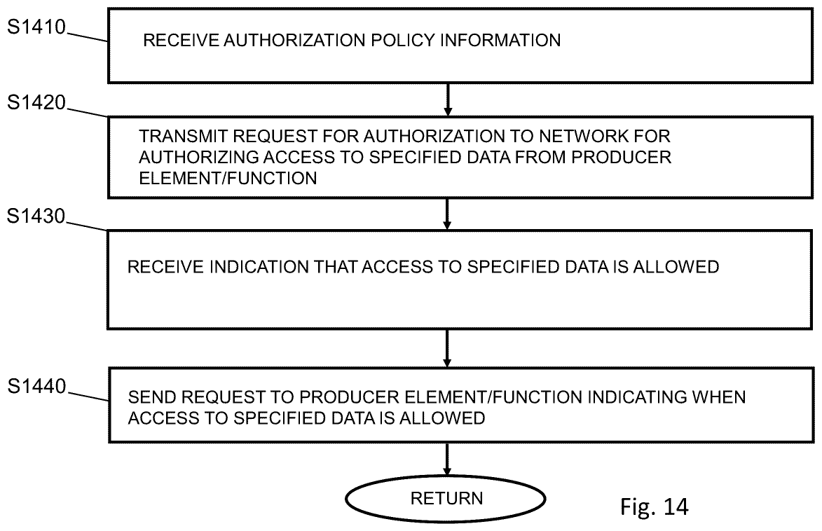

FIG. 14 shows a flow chart of a processing conducted in requester UE, such as UE1, which conducts an authorization procedure according to some examples of the embodiments, as described in connection with FIGS. 5 and 6. That is, FIG. 14 shows a flowchart related to a processing conducted by a requester UE of PLMN1 of FIG. 1 or FIG. 2.

In S1410, configuration information regarding an authorization policy is received from a control network element or control network function. The policy information indicates an allowance for connection between a requester UE and a producer element or a producer function (e.g. UE2).

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

According to examples of embodiments, the authorization policy information comprises at least one of the following: an ID of a source UE of the request, an ID of a producer element or producer function of the requested data, an ID of a communication network where the producer element or producer function of the requested data is located, or an indication of a connection type to be used for obtaining the requested data from the producer element or producer function.

In S1420 a request for authorization to access to specified data from a producer element or producer function is sent to the control network element or control network function (i.e. the control entity of PLMN1, for example).

According to examples of embodiments, the producer element or producer function indicated in the request for authorization to access to the specified data is one of a producer UE or a producer communication network element or producer communication network function (e.g. RAN or 5GC, or the like).

Furthermore, according to examples of embodiments, the specified data indicated in the request for authorization of the requester UE include at least one of the following: AIML model data, AIML training data, or AIML analysis data.

Moreover, according to examples of embodiments, the request for authorization includes an identification of a producer element or producer function.

In S1430, in response to the request for authorization, the requester UE receives an indication that the access to the specified data from the producer element or producer function is allowed.

According to examples of embodiments, the indication of the authorization further comprises information related to the producer element or producer function (e.g. UE2).

In S1440, after receiving the indication that the access to the specified data from the producer element or producer function is allowed in S1430, the requester UE sends a request to the producer element or producer function for being provided with the specified data.

According to further examples of embodiments, as described in connection with FIG. 6, a unique temporary ID is obtained which is assigned for preserving privacy in a D2D communication. The unique temporary ID is received from the control entity, or is generated in the requester UE. The unique temporary ID is indicated in the request for authorization to access the specified data available at the producer element or producer function identified by unique temporary identifier.

Furthermore, according to examples of embodiments, as described in connection with FIG. 6, the requester UE receives from a producer element or producer function from which specified data are to be obtained, a unique temporary ID of the producer element or producer function assigned for preserving privacy in a D2D communication. This unique temporary ID is indicated as an identification of the producer element or producer function in the request for authorization to access the specified data being sent in S1420.

According to examples of embodiments, in response to the request in S1440, the requested specified data are received from the producer element or producer function.

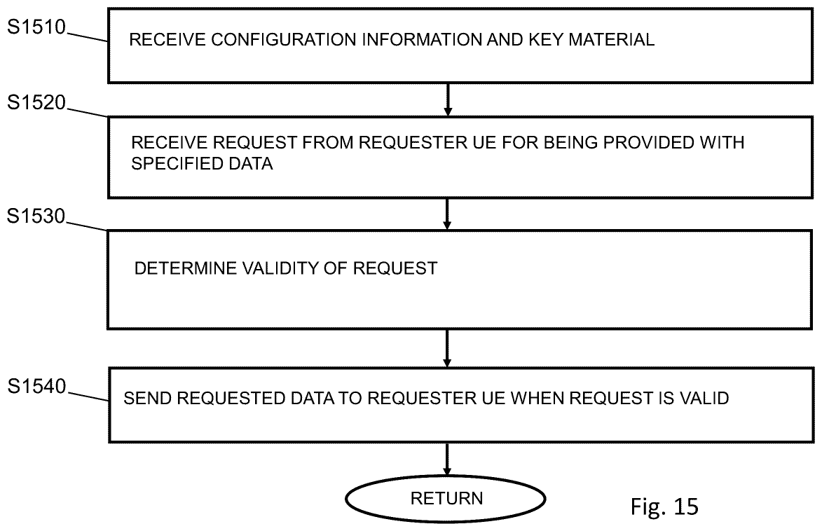

FIG. 15 shows a flow chart of a processing conducted in producer element or producer function, i.e. a producer UE like UE2 or a producer communication network element or a producer communication network function such as a RAN or 5GC element or function, which conducts an authorization procedure according to some examples of the embodiments, as described in connection with FIGS. 5 and 6. That is, FIG. 15 shows a flowchart related to a processing conducted by a producer UE2 of PLMN1 or PLMN 2 of FIG. 1 or FIG. 2.

In S1510, configuration information regarding an authorization policy is received from a control network element or control network function. The information includes authorization policy information indicating an allowance for connection between a requester user equipment and a producer element or a producer function.

According to examples of embodiments, the data allowed to be accessed to which the authorization policy is related and the specified data which are requested to be accessed concern data related to AIML services. In this case, the one or more UEs configured with the authorization policy are UEs being signed to use one or more AIML services, for example.

In S1520, a request for specified data to be provided from a producer element or producer function is received from a requester UE (e.g. UE1).

According to examples of embodiments, the specified data indicated in the request for authorization of the requester UE include at least one of the following: AIML model data, AIML training data, or AIML analysis data.

According to further examples of embodiments, it is also possible that an update for the authorization policy information is received from the control network element or control network function.

In S1530, a validity of the request of S1520 is determined on the basis of the received authorization policy information (i.e. the originally received or the updated authorization policy information).

According to examples of embodiments, the authorization policy information comprises at least one of the following: an ID of a source UE of the request, an ID of a producer element or producer function of the requested data, an ID of a communication network where the producer element or producer function of the requested data is located, or an indication of a connection type to be used for obtaining the requested data from the producer element or producer function.

In S1540, if the validity of the request is confirmed, the requested specified data are sent to the requester UE.

According to further examples of embodiments, as described in connection with FIG. 6, a unique temporary ID is obtained which is assigned for preserving privacy in a D2D communication. The unique temporary ID is received from the control entity, or is generated in the producer element or producer function. The unique temporary ID is indicated to a requestor UE trying to access specified data.

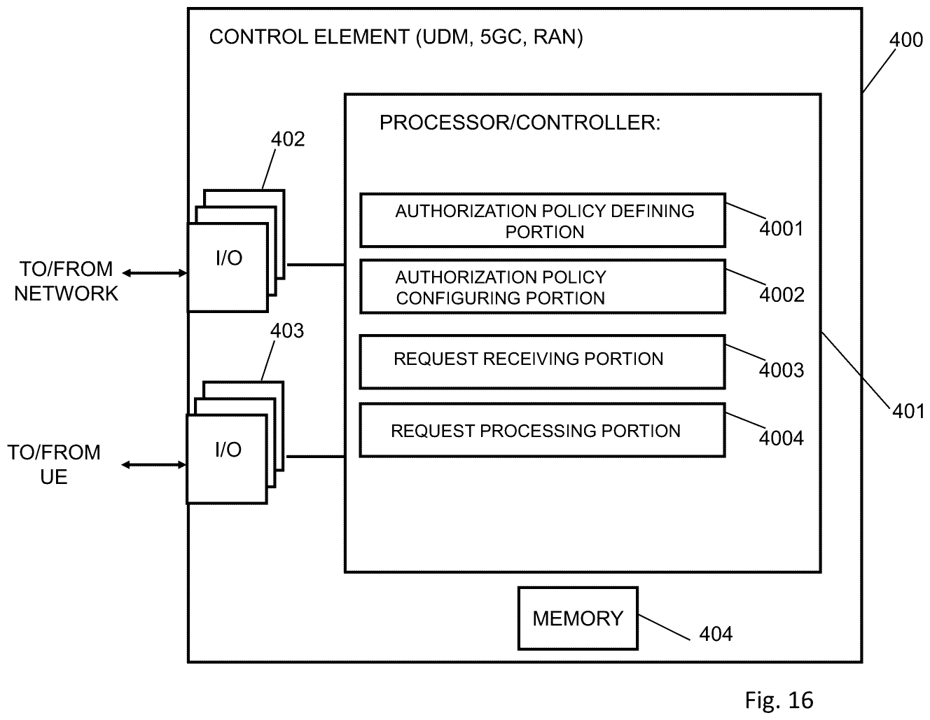

FIG. 16 shows a diagram of a network element or network function 400, such as a 5GC network element or function, a RAN element or function, or a UDM, which conducts an authorization procedure as a control entity according to some examples of the embodiments, as described in connection with FIGS. 5 and 6. It is to be noted that the network element or function 400, such as the UDM as the control entity, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The control entity 400 shown in FIG. 16 may include a processing circuitry, a processing function, a control unit or a processor 401, such as a CPU or the like, which is suitable for executing instructions given by programs or the like related to the control procedure. The processor 401 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 402 and 403 denote input/output (I/O) units or functions (interfaces) connected to the processor or processing function 401. The I/O units 402 may be used for communicating with a network part. The I/O units 403 may be used for communicating with a UE, such as the UE1 or UE2. The I/O units 402 and 403 may be combined units including communication equipment towards several entities, or may include a distributed structure with a plurality of different interfaces for different entities. Reference sign 404 denotes a memory usable, for example, for storing data and programs to be executed by the processor or processing function 401 and/or as a working storage of the processor or processing function 401. It is to be noted that the memory 404 may be implemented by using one or more memory portions of the same or different type of memory.

The processor or processing function 401 is configured to execute processing related to the above described authorization procedure. In particular, the processor or processing circuitry or function 401 includes one or more of the following sub-portions. Sub-portion 4001 is a processing portion which is usable as a portion for defining an authorization policy. The portion 4001 may be configured to perform processing according to S1310 of FIG. 13. Furthermore, the processor or processing circuitry or function 401 may include a sub-portion 4002 usable as a portion for configuring an authorization policy. The portion 4002 may be configured to perform a processing according to S1320 of FIG. 13. In addition, the processor or processing circuitry or function 401 may include a sub-portion 4003 usable as a portion for receiving a request. The portion 4003 may be configured to perform a processing according to S1330 of FIG. 13. Furthermore, the processor or processing circuitry or function 401 may include a sub-portion 4004 usable as a portion for processing a request. The portion 4004 may be configured to perform a processing according to S1340 of FIG. 13.

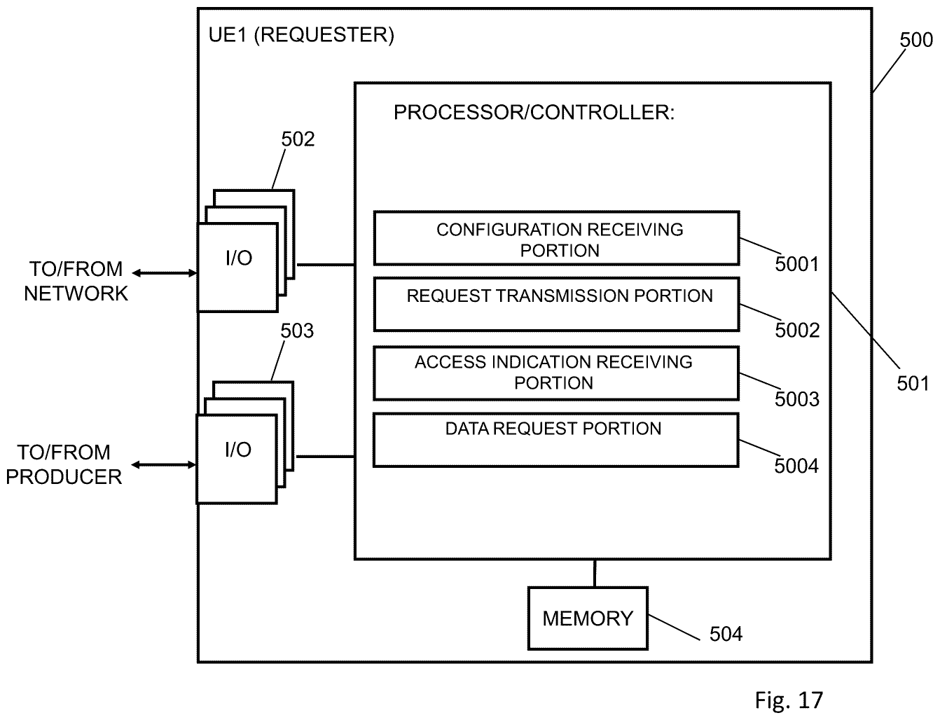

FIG. 17 shows a diagram of a network element or network function 500, such as UE1, which conducts an authorization procedure as a requester UE according to some examples of the embodiments, as described in connection with FIGS. 5 and 6. It is to be noted that the network element or function 500, such as the UE1, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The requester UE1 500 shown in FIG. 17 may include a processing circuitry, a processing function, a control unit or a processor 501, such as a CPU or the like, which is suitable for executing instructions given by programs or the like related to the control procedure. The processor 501 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 502 and 503 denote input/output (I/O) units or functions (interfaces) connected to the processor or processing function 501.

The I/O units 502 may be used for communicating with a communication network, such as PLMN1. The I/O units 503 may be used for directly communicating with another UE, such as the UE2 via D2D or the like. The I/O units 502 and 503 may be combined units including communication equipment towards several entities, or may include a distributed structure with a plurality of different interfaces for different entities. Reference sign 504 denotes a memory usable, for example, for storing data and programs to be executed by the processor or processing function 501 and/or as a working storage of the processor or processing function 501. It is to be noted that the memory 504 may be implemented by using one or more memory portions of the same or different type of memory.

The processor or processing function 501 is configured to execute processing related to the above described authorization procedure. In particular, the processor or processing circuitry or function 501 includes one or more of the following sub-portions. Sub-portion 5001 is a processing portion which is usable as a portion for receiving configuration information. The portion 5001 may be configured to perform processing according to S1410 of FIG. 14. Furthermore, the processor or processing circuitry or function 501 may include a sub-portion 5002 usable as a portion for transmitting a request. The portion 5002 may be configured to perform a processing according to S1420 of FIG. 14. In addition, the processor or processing circuitry or function 501 may include a sub-portion 5003 usable as a portion for receiving an access indication. The portion 5003 may be configured to perform a processing according to S1430 of FIG. 14. Furthermore, the processor or processing circuitry or function 501 may include a sub-portion 5004 usable as a portion for requesting data. The portion 5004 may be configured to perform a processing according to S1440 of FIG. 14.

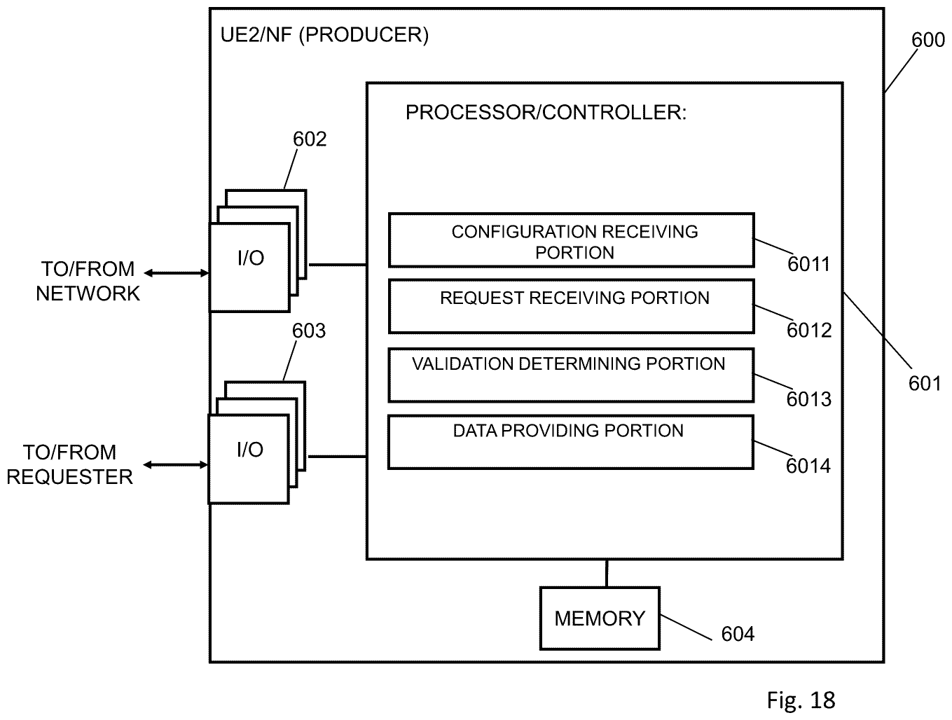

FIG. 18 shows a diagram of a network element or network function 500, such as UE2, which conducts an authorization procedure as a producer element or function according to some examples of the embodiments, as described in connection with FIGS. 5 and 6. It is to be noted that the network element or function 600, such as the UE2, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The producer UE2 600 shown in FIG. 18 may include a processing circuitry, a processing function, a control unit or a processor 601, such as a CPU or the like, which is suitable for executing instructions given by programs or the like related to the control procedure. The processor 601 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 602 and 603 denote input/output (I/O) units or functions (interfaces) connected to the processor or processing function 601. The I/O units 602 may be used for communicating with a communication network, such as PLMN1 or PLMN2. The I/O units 603 may be used for directly communicating with another UE, such as the UE1 via D2D or the like. The I/O units 602 and 603 may be combined units including communication equipment towards several entities, or may include a distributed structure with a plurality of different interfaces for different entities. Reference sign 604 denotes a memory usable, for example, for storing data and programs to be executed by the processor or processing function 601 and/or as a working storage of the processor or processing function 601. It is to be noted that the memory 604 may be implemented by using one or more memory portions of the same or different type of memory.

The processor or processing function 601 is configured to execute processing related to the above described authorization procedure. In particular, the processor or processing circuitry or function 601 includes one or more of the following sub-portions. Sub-portion 6011 is a processing portion which is usable as a portion for receiving configuration information. The portion 6011 may be configured to perform processing according to S1510 of FIG. 15. Furthermore, the processor or processing circuitry or function 601 may include a sub-portion 6012 usable as a portion for receiving a request. The portion 6012 may be configured to perform a processing according to S1520 of FIG. 15. In addition, the processor or processing circuitry or function 601 may include a sub-portion 6013 usable as a portion for determination a validation. The portion 6013 may be configured to perform a processing according to S1530 of FIG. 15. Furthermore, the processor or processing circuitry or function 601 may include a sub-portion 6014 usable as a portion for providing data. The portion 6014 may be configured to perform a processing according to S1540 of FIG. 15.

According to a further example of embodiments, there is provided, for example, an apparatus comprising means configured to define an authorization policy per user equipment, the authorization policy indicating which data are allowed to be accessed by which user equipment, means configured to configure an authorization policy to one or more user equipments by providing a key material usable for validating an access token and information regarding the authorization policy indicating an allowance for connection between a requester user equipment and a producer element or a producer function with a valid access token or without an access token, means configured to receive a request for authorization of a requester user equipment to access to specified data from a producer element or producer function, means configured to process the request for authorization of the requester user equipment for deciding whether the request is allowed, and in case the request is allowed, means configured to obtain an access token for allowing access to the specified data from the producer element or producer function, and means configured to transmit the access token to the requester user equipment.

Furthermore, according to some other examples of embodiments, the above defined apparatus may further comprise means for conducting at least one of the processing defined in the above described methods, for example a method according to that described in connection with FIG. 7.

According to a further example of embodiments, there is provided, for example, an apparatus comprising means configured to receive configuration information regarding an authorization policy from a control network element or control network function including key material usable for validating an access token and information indicating an allowance for connection between a requester user equipment and a producer element or a producer function with a valid access token or without an access token, means configured to transmit, to the control network element or control network function, a request for authorization to access to specified data from a producer element or producer function, means configured to receive, in response to the request, an access token for allowing access to the specified data from the producer element or producer function, and means configured to send a request to the producer element or producer function for being provided with the specified data, wherein the received access token is included in the request.

Furthermore, according to some other examples of embodiments, the above defined apparatus may further comprise means for conducting at least one of the processing defined in the above described methods, for example a method according to that described in connection with FIG. 8.

According to a further example of embodiments, there is provided, for example, an apparatus comprising means configured to receive configuration information regarding an authorization policy from a control network element or control network function including key material usable for validating an access token and information indicating an allowance for connection between a requester user equipment and a producer element or a producer function with a valid access token or without an access token, means configured to receive, from a requester user equipment, a request for specified data to be provided from a producer element or producer function, wherein the request comprises an access token for allowing access to the specified data from the producer element or producer function, means configured to determine a validity of the received access token, and if validity of the access token is confirmed, means configured to send the requested specified data to the requester user equipment.

Furthermore, according to some other examples of embodiments, the above defined apparatus may further comprise means for conducting at least one of the processing defined in the above described methods, for example a method according to that described in connection with FIG. 9.

According to a further example of embodiments, there is provided, for example, an apparatus comprising means configured to define an authorization policy per user equipment, the authorization policy indicating which data are allowed to be accessed by which user equipment, means configured to configure an authorization policy by pushing authorization policy information to a network element or network function and to one or more user equipments, the authorization policy information indicating an allowance for connection between a requester user equipment and a producer element or a producer function, means configured to receive a request for authorization of a requester user equipment to access to specified data from a producer element or producer function, means configured to process the request for authorization of the requester user equipment for deciding whether the request is allowed.

Furthermore, according to some other examples of embodiments, the above defined apparatus may further comprise means for conducting at least one of the processing defined in the above described methods, for example a method according to that described in connection with FIG. 13.

According to a further example of embodiments, there is provided, for example, an apparatus comprising means configured to receive, from a control network element or control network function, authorization policy information indicating an allowance for connection between a requester user equipment and a producer element or a producer function, means configured to transmit, to the control network element or control network function, a request for authorization to access to specified data from a producer element or producer function, means configured to receive, in response to the request, an indication that the access to the specified data from the producer element or producer function is allowed, and means configured to send, after receiving the indication that the access to the specified data from the producer element or producer function is allowed, a request to the producer element or producer function for being provided with the specified data.

Furthermore, according to some other examples of embodiments, the above defined apparatus may further comprise means for conducting at least one of the processing defined in the above described methods, for example a method according to that described in connection with FIG. 14.

According to a further example of embodiments, there is provided, for example, an apparatus comprising means configured to receive, from a control network element or control network function, authorization policy information indicating an allowance for connection between a requester user equipment and a producer element or a producer function, means configured to receive, from a requester user equipment, a request for specified data to be provided from a producer element or producer function, means configured to determine a validity of the request on the basis of the received authorization policy information, and if validity of the request is confirmed, means configured to send the requested specified data to the requester user equipment.

Furthermore, according to some other examples of embodiments, the above defined apparatus may further comprise means for conducting at least one of the processing defined in the above described methods, for example a method according to that described in connection with FIG. 15.

According to a further example of embodiments, there is provided, for example, a non-transitory computer readable medium comprising program instructions for causing an apparatus to perform a processing comprising defining an authorization policy per user equipment, the authorization policy indicating which data are allowed to be accessed by which user equipment, configuring an authorization policy to one or more user equipments by providing a key material usable for validating an access token and information regarding the authorization policy indicating an allowance for connection between a requester user equipment and a producer element or a producer function with a valid access token or without an access token, receiving a request for authorization of a requester user equipment to access to specified data from a producer element or producer function, processing the request for authorization of the requester user equipment for deciding whether the request is allowed, and in case the request is allowed, obtaining an access token for allowing access to the specified data from the producer element or producer function, and transmitting the access token to the requester user equipment.

According to a further example of embodiments, there is provided, for example, a non-transitory computer readable medium comprising program instructions for causing an apparatus to perform a processing comprising receiving configuration information regarding an authorization policy from a control network element or control network function including key material usable for validating an access token and information indicating an allowance for connection between a requester user equipment and a producer element or a producer function with a valid access token or without an access token, transmitting, to the control network element or control network function, a request for authorization to access to specified data from a producer element or producer function, receiving, in response to the request, an access token for allowing access to the specified data from the producer element or producer function, and sending a request to the producer element or producer function for being provided with the specified data, wherein the received access token is included in the request.

According to a further example of embodiments, there is provided, for example, a non-transitory computer readable medium comprising program instructions for causing an apparatus to perform a processing comprising receiving configuration information regarding an authorization policy from a control network element or control network function including key material usable for validating an access token and information indicating an allowance for connection between a requester user equipment and a producer element or a producer function with a valid access token or without an access token, receiving, from a requester user equipment, a request for specified data to be provided from a producer element or producer function, wherein the request comprises an access token for allowing access to the specified data from the producer element or producer function, determining a validity of the received access token, and if validity of the access token is confirmed, sending the requested specified data to the requester user equipment.

According to a further example of embodiments, there is provided, for example, a non-transitory computer readable medium comprising program instructions for causing an apparatus to perform a processing comprising defining an authorization policy per user equipment, the authorization policy indicating which data are allowed to be accessed by which user equipment, configuring an authorization policy by pushing authorization policy information to a network element or network function and to one or more user equipments, the authorization policy information indicating an allowance for connection between a requester user equipment and a producer element or a producer function receiving a request for authorization of a requester user equipment to access to specified data from a producer element or producer function, processing the request for authorization of the requester user equipment for deciding whether the request is allowed.

According to a further example of embodiments, there is provided, for example, a non-transitory computer readable medium comprising program instructions for causing an apparatus to perform a processing comprising receiving, from a control network element or control network function, authorization policy information indicating an allowance for connection between a requester user equipment and a producer element or a producer function, transmitting, to the control network element or control network function, a request for authorization to access to specified data from a producer element or producer function, receiving, in response to the request, an indication that the access to the specified data from the producer element or producer function is allowed, and sending, after receiving the indication that the access to the specified data from the producer element or producer function is allowed, a request to the producer element or producer function for being provided with the specified data.

According to a further example of embodiments, there is provided, for example, a non-transitory computer readable medium comprising program instructions for causing an apparatus to perform a processing comprising receiving, from a control network element or control network function, authorization policy information indicating an allowance for connection between a requester user equipment and a producer element or a producer function, receiving, from a requester user equipment, a request for specified data to be provided from a producer element or producer function, determining a validity of the request on the basis of the received authorization policy information, and if validity of the request is confirmed, sending the requested specified data to the requester user equipment.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines;
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler;
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic);
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions 5 dedicated to specific processing as described;
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components;
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1. An apparatus comprising
at least one processor, and
at least one memory for storing instructions that, when executed by the at least one processor, cause the apparatus at least to perform:
defining an authorization policy per user equipment, the authorization policy indicating which data are allowed to be accessed by which user equipment,
configuring an authorization policy to one or more user equipments by providing a key material usable for validating an access token and information regarding the authorization policy indicating an allowance for connection between a requester user equipment and a producer element or a producer function with a valid access token or without an access token,
receiving a request for authorization of a requester user equipment to access to specified data from a producer element or producer function,
processing the request for authorization of the requester user equipment for deciding whether the request is allowed, and
in case the request is allowed, obtaining an access token for allowing access to the specified data from the producer element or producer function, and
transmitting the access token to the requester user equipment.

2. The apparatus according to claim 1, wherein the data allowed to be accessed to which the authorization policy is related and the specified data which are requested to be accessed concern data related to artificial intelligence machine learning, AIML, services, wherein the one or more user equipments configured with the authorization policy are user equipments being signed to use one or more AIML services.

3. The apparatus according to claim 1, wherein the instructions, when executed by the at least one processor, cause the apparatus at least to perform:
for providing the key material and the information regarding the authorization policy, using one of a non-access stratum, NAS, signalling or a user parameter provisioning signaling for a transmission to the one or more user equipments.

4. The apparatus according to claim 1, wherein the data indicated in the authorization policy comprises at least one or more of the following:
an AIML model identification,
an AIML event identification, or
a data topic identification,
wherein user equipments allowed to access the data are identified by at least one of the following:
a predefined list of user equipments,
an indication of an specified area where a user equipment is located,
an indication of a communication network to which a user equipment belongs, or
an indication that any user equipment is allowed.

5. The apparatus according to claim 1, wherein the request for authorization of the requester user equipment is received from one of the requester user equipment or from a control network element or control network function of another communication network.

6. The apparatus according to claim 1, wherein the instructions, when executed by the at least one processor, cause the apparatus at least to perform:
indicating, with the access token transmitted to the requester user equipment, information indicating at least one the following:
information identifying at least one producer element or producer function for prompting the requester user equipment to contact only an identified producer element or producer function as a target for requesting the specified data, or
information indicating specified resources of data for prompting the requester user equipment to request only the indicated resources from a suitable producer element or producer function, wherein the access token is a generic access token.

7. The apparatus according to claim 1, wherein the instructions, when executed by the at least one processor, cause the apparatus at least to perform:
determining, when receiving the request for authorization of the requester user equipment, whether a unique temporary identifier for the producer element or producer function is included which is related to another communication network, and
in case the determination is affirmative, forwarding the request for authorization of the requester user equipment to a control network element or control network function of the other communication network for obtaining the access token,
receiving the access token from the control network element or control network function of the other communication network, and
transmitting the received access token to the requester user equipment.

8. The apparatus according to claim 7, wherein the unique temporary identifier is
configured in the producer element or producer function by a control network element or control network function, or
generated by the producer element or producer function.

9. The apparatus according to claim 1, wherein the instructions, when executed by the at least one processor, cause the apparatus at least to perform:
when the processing of the request for authorization of the requester user equipment is decided to be allowed, generate the access token for allowing access to the specified data from the producer element or producer function, and
transmitting the generated access token to the requester user equipment.

10. The apparatus according to claim 1, wherein the instructions, when executed by the at least one processor, cause the apparatus at least to perform:
for processing of the request for authorization of the requester user equipment, deciding on whether the request is allowed or not on the basis of an operator policy and subscription data of the producer element or producer function.

11. The apparatus according to claim 1, wherein the access token comprises at least one of the following:
an identification of a source user equipment of the request, an identification of a producer element or producer function of the requested data, an identification of a communication network where the producer element or producer function of the requested data is located, or an indication of a connection type to be used for obtaining the requested data from the producer element or producer function.

12. The apparatus according to claim 1, wherein the access token is signed by a private key, wherein the key material is a corresponding public key used to validate the access token at the producer element or producer function.

13. The apparatus according to claim 1, wherein the specified data indicated in the request for authorization of the requester user equipment include at least one of the following:
AIML model data,
AIML training data, or
AIML analysis data.

14. The apparatus according to claim 1, wherein the request for authorization of the requester user equipment includes an identification of a producer element or producer function.

15. The apparatus according to claim 1, wherein the apparatus comprises or is comprised in one of a core network control element or core network control function, an access network control element or access network control function, or
wherein the apparatus comprises or is comprised in a unified data management entity.

16. An apparatus comprising
at least one processor, and
at least one memory for storing instructions that, when executed by the at least one processor, cause the apparatus at least to perform:
receiving configuration information regarding an authorization policy from a control network element or control network function including key material usable for validating an access token and information indicating an allowance for connection between a requester user equipment and a producer element or a producer function with a valid access token or without an access token,
transmitting, to the control network element or control network function, a request for authorization to access to specified data from a producer element or producer function,
receiving, in response to the request, an access token for allowing access to the specified data from the producer element or producer function, and
sending a request to the producer element or producer function for being provided with the specified data, wherein the received access token is included in the request.

17. The apparatus according to claim 16, wherein the data allowed to be accessed to which the authorization policy is related and the specified data which are requested to be accessed concern data related to artificial intelligence machine learning, AIML, services, wherein the one or more user equipments configured with the authorization policy are user equipments being signed to use one or more AIML services.

18. The apparatus according to claim 16, wherein the instructions, when executed by the at least one processor, cause the apparatus at least to perform:
receiving the key material and the information regarding the authorization policy by using one of a non-access stratum, NAS, signalling or a user parameter provisioning signaling for a transmission from the control network element or control network function.

19. An apparatus comprising
at least one processor, and
at least one memory for storing instructions that, when executed by the at least one processor, cause the apparatus at least to perform:
receiving configuration information regarding an authorization policy from a control network element or control network function including key material usable for validating an access token and information indicating an allowance for connection between a requester user equipment and a producer element or a producer function with a valid access token or without an access token,
receiving, from a requester user equipment, a request for specified data to be provided from a producer element or producer function, wherein the request comprises an access token for allowing access to the specified data from the producer element or producer function,
determining a validity of the received access token, and
if validity of the access token is confirmed, sending the requested specified data to the requester user equipment.

20. The apparatus according to claim 19, wherein the data allowed to be accessed to which the authorization policy is related and the specified data which are requested to be accessed concern data related to artificial intelligence machine learning, AIML, services, wherein the one or more user equipments configured with the authorization policy are user equipments being signed to use one or more AIML services.
